(19) United States
(12) Patent Application Publication
(10) Pub. No.: US 2026/0107310 A1
(43) Pub. Date: Apr. 16, 2026

(54) Station-Assisted Multi-Access Point Coordination

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 19/419,539

(22) Filed: Dec. 15, 2025

Related U.S. Application Data
(63) Continuation of application No. PCT/US2024/034062, filed on Jun. 14, 2024.
(60) Provisional application No. 63/521,407, filed on Jun. 16, 2023.

(51) Int. Cl. H04W 74/0816; H04B 17/309; H04B 17/318; H04W 74/04

(52) U.S. Cl. CPC H04W 74/0816; H04B 17/318; H04B 17/346; H04W 74/04

(57) ABSTRACT

A first access point (AP) receives from a station (STA), a first frame indicating: a first period for communication by a second AP, and a first received signal strength indicator based on a transmission from the second AP. The first AP transmits a second frame indicating a second period for communication by the first AP, with the second period for communication based on the first period for communication by the second AP and the first received signal strength indicator.

### CROSS-REFERENCE TO RELATED APPLICATIONS

This application is a continuation of International Application No. PCT/US2024/034062, filed June 14, 2024, which claims the benefit of U.S. Provisional Application No. 63/521,407, filed June 16, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example multi-AP network.

FIG. 4 illustrates Enhanced Distributed Channel Access (EDCA) and Coordinated Orthogonal Frequency Division Multiple Access (COFDMA).

FIG. 5 illustrates an example network that includes a coordinated AP set.

FIG. 6 illustrates an example multi-AP operation procedure.

FIG. 7 illustrates an example multi-AP sounding phase.

FIG. 8 illustrates an example multi-AP downlink data transmission phase.

FIG. 9 illustrates an example multi-AP uplink data transmission phase.

FIG. 10 illustrates an example of interference that may be incurred by a STA operating in proximity to multiple APs.

FIG. 11 is an example that illustrates station-assisted multi-AP coordination according to an embodiment.

FIG. 12 is an example that illustrates station-assisted multi-AP coordination according to another embodiment.

FIG. 13 illustrates a restricted target wake time (R-TWT) element which may be used in embodiments.

FIG. 14 illustrates a control wrapper frame which may be used in embodiments.

FIG. 15 illustrates an example process according to an embodiment.

FIG. 16 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B = {STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

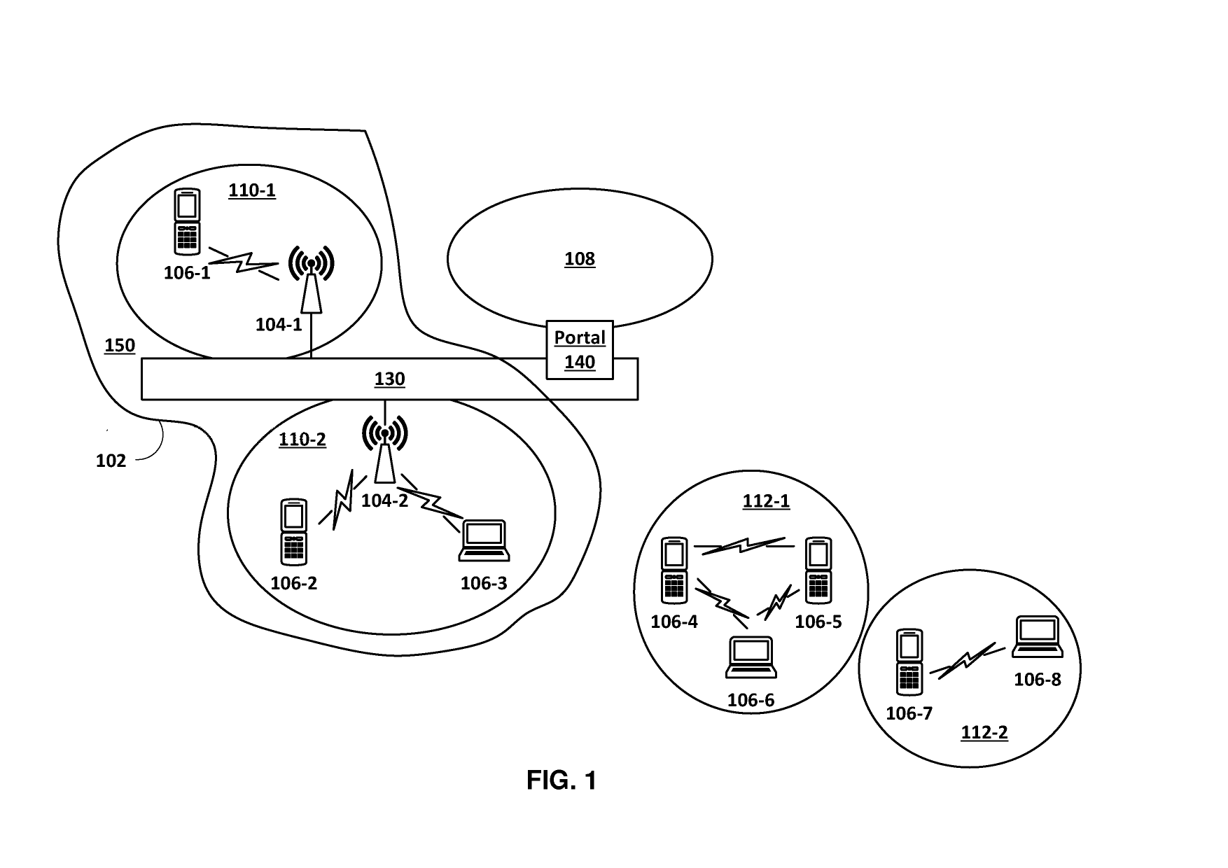

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other..

DS 130 may be configured to connect BSS 110-1 and BSS 110-2. As such, DS 130 may enable an extended service set (ESS) 150. Within ESS 150, APs 104-1 and 104-2 are connected via DS 130and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

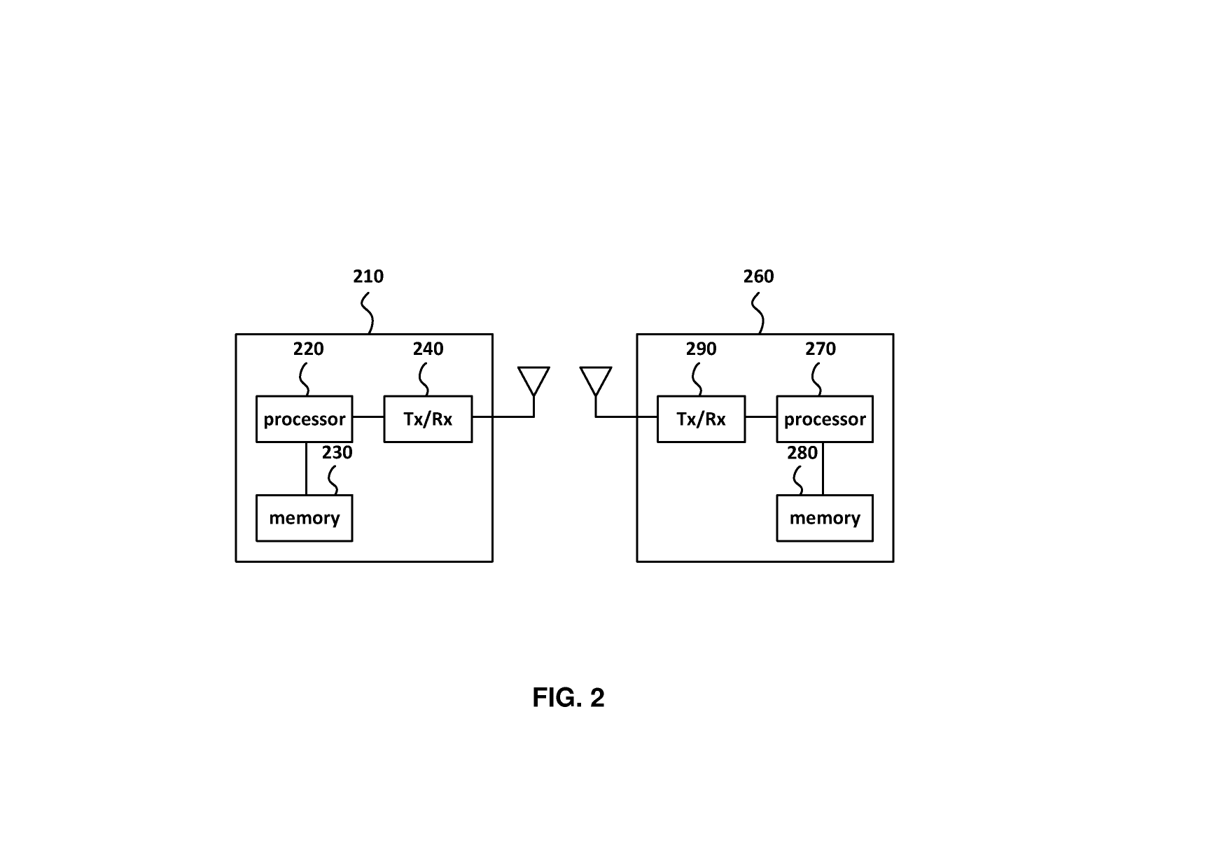

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

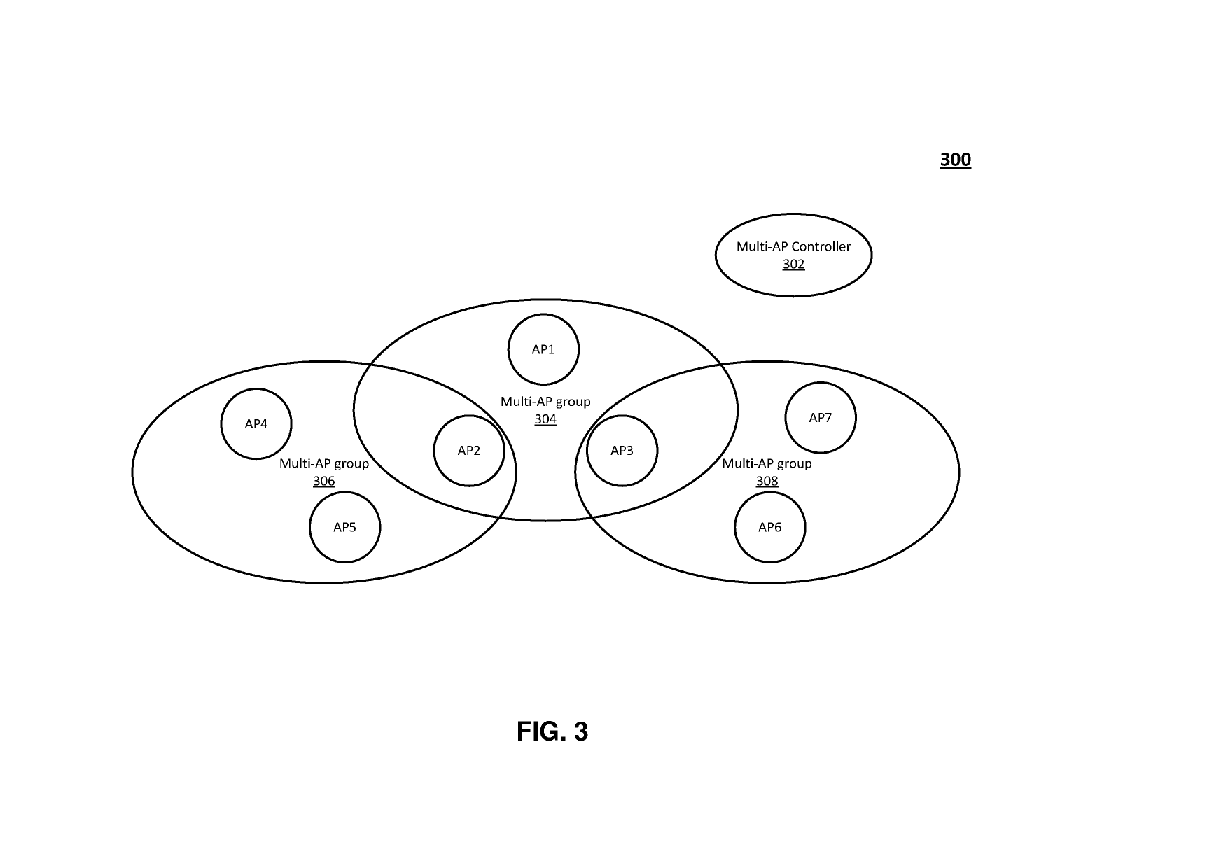

FIG. 3 illustrates an example multi-AP network 300. Example multi-AP network 300 may be a multi-AP network in accordance with the Wi-Fi Alliance standard specification for multi-AP networks. As shown in FIG. 3, multi-AP network 300 may include a multi-AP controller 302 and a plurality of multi-AP groups (or multi-AP sets) 304, 306, and 308.

Multi-AP controller 302 may be a logical entity that implements logic for controlling the APs in multi-AP network 300. Multi-AP controller 302 may receive capability information and measurements from the APs and may trigger AP control commands and operations on the APs. Multi-AP controller 302 may also provide onboarding functionality to onboard and provision APs onto multi-AP network 300.

Multi-AP groups 304, 306, and 308 may each include a plurality of APs. APs in a multi-AP group are in communication range of each other and may coordinate their transmissions and/or transmissions from their associated STAs. Coordinated transmissions may involve all or a subset of the APs in a multi-AP group. A multi-AP group may also be referred to as an AP candidate set as APs in a multi-AP group are considered candidates for a coordinated transmission initiated by an AP. The APs in a multi-AP group are not required to have the same primary channel. As used herein, the primary channel for an AP refers to a default channel that the AP monitors for management frames and/or uses to transmit beacon frames. For a STA associated with an AP, the primary channel refers to the primary channel of the AP, which is advertised through the AP’s beacon frames.

In one approach, a multi-AP group may be established by a coordinator AP in a multi-AP setup phase prior to any multi-AP coordination. APs of the multi-AP group, other than the coordinator AP, may be referred to as the coordinated APs. A coordinator AP may establish one or more multi-AP groups. A coordinated AP may likewise be a member of multiple multi-AP groups. A coordinator AP of a multi-AP group may be a coordinated AP of another multi-AP group, and vice versa. In another approach, a multi-AP group may be established by a network administrator manually by configuring APs as part of the multi-AP group. In yet another approach, a multi-AP group may be established in a distributed manner by APs without a central controller. In this case, an AP may advertise its multi-AP capability in a beacon or other management frame (e.g., public action frame). Other APs that receive the frame with the multi-AP capability information may perform a multi-AP setup with the AP that advertised the multi-AP capability.

In one approach, one of the APs in a multi-AP group may be designated as a master AP. The designation of the master AP may be done by AP controller 302 or by the APs of the multi-AP group. The master AP of a multi-AP group may be fixed or may change over time between the APs of the multi-AP group. An AP that is not the master AP of the multi-AP group is known as a slave AP.

In one approach, APs in a multi-AP group may perform coordinated transmissions together. One aspect of coordination may include coordination to perform coordinated transmissions within the multi-AP group. As used herein, a coordinated transmission, also referred to as a multi-AP transmission, is a transmission event in which multiple APs (of a multi-AP group or a multi-AP network) transmit in a coordinated manner over a time period. Coordinated transmissions may involve simultaneous transmissions of a plurality of APs in a multi-AP group. The time period of simultaneous AP transmission may be a continuous period. The multi-AP transmission may use different transmission techniques, such as Coordinated OFDMA (COFDMA), Coordinated Spatial Reuse (CSR), Joint Transmission or Reception (JT/JR), Coordinated Beamforming (CBF), and CTDMA, or a combination of two or more of the aforementioned techniques.

Multi-AP transmissions may be enabled by the AP controller and/or by the master AP of the multi-AP group. In one approach, the AP controller and/or the master AP may control time and/or frequency sharing in a transmission opportunity (TXOP). For example, when one of the APs (e.g., the master AP) in the multi-AP group obtains a TXOP, the AP controller and/or the master AP may control how time/frequency resources of the TXOP are to be shared with other APs of the multi-AP group. In an implementation, the AP of the multi-AP group that obtains a TXOP becomes the master AP of the multi-AP group. The master AP may then share a portion of its obtained TXOP (which may be the entire TXOP) with one or more other APs of the multi-AP group.

Different multi-AP transmission schemes may be suitable for different use cases in terms of privacy protection, including whether transmitted data may be shared with other BSSs in the multi-AP group. For example, some multi-AP transmission schemes, such as CSR, CDTMA, coordinated frequency division multiple access (CFDMA), COFDMA, and CBF, enable a master AP to coordinate slave APs by sharing control information among APs, without requiring the sharing of user data among APs. The control information may include BSS information of APs, link quality information of channels between each AP and its associated STAs, and information related to resources to be used to achieve multiplexing in power, time, frequency, or special domains for multi-AP transmission. The control information exchanged among a master AP and slave APs may be used for interference avoidance or nulling to avoid or null co-channel interference introduced to neighboring BSSs in a multi-AP network. Interference avoidance or interference nulling requires that data transmissions between an AP and STAs are only within the same BSS. In other words, each AP transmits or receives data frames to or from its associated STAs, while each STA receives or transmits data frames to or from its associating AP.

By contrast, other multi-AP transmission schemes may enable a master AP to coordinate slave APs by sharing both control information and user data among APs in a multi-AP group. Control information may include BSS information related to APs and link quality information of channels between each AP and its associated STAs. By having user data exchanged over backhaul, the master AP and slave APs may perform data transmissions jointly to achieve spatial diversity, e.g., using distributed MIMO, for example, joint transmission (JT) for downlink transmissions and joint reception (JR) for uplink transmissions. The data transmissions between APs and STAs may include transmissions within the same BSS and/or across different BSSs. In other words, an AP may transmit or receive data frames to or from its associated STAs as well STAs associated with other APs participating in multi-AP transmission. Similarly, a STA may transmit or receive data frames to or from multiple APs.

Different multi-AP transmission schemes may be suitable for different use cases in terms of signal reception levels at STAs or APs within a multi-AP group. For example, CBF and JT/JR require that each STA involved in a multi-AP transmission be located within a common area of signal coverage of the APs involved in the multi-AP transmission. Generally, CBF may be suitable when a receiving STA suffers from potential interference from other APs in the multi-AP group. By using channel related information such as channel state information (CSI), channel quality indication (CQI), or compressed beamforming (BF) feedback exchanged among APs, an AP may pre-code a signal to be transmitted to form a beam that increases power toward a target STA while reducing the power that interferes with a STA associated with a neighboring AP. Use cases of JT/JR may require a sufficient received signal power at receiving STAs for JT and a sufficient received signal power at receiving APs for JR. By contrast, CSR may perform multi-AP transmission in an interference coordination manner. The received signal power at a STA associated with an AP transmitting data may be required to be much higher than the received interference power.

Different multi-AP transmission schemes may require different synchronization levels and may operate with or without a backhaul between a master AP and slave APs in a multi-AP group. For example, CSR may require PPDU-level synchronization, whereas CBF may require symbol-level synchronization. On the other hand, JT/JR may require tight time/frequency/phase-level synchronization as well as a backhaul for data sharing between APs in the multi-AP group.

Different multi-AP transmission schemes may have different complexity levels with regard to coordination between a master AP and slave APs in a multi-AP group. For example, JT/JR may require very high complexity due to both CSI and user data being shared between APs. CBF may require medium complexity due to the sharing of CSI. CFDMA, COFDMA and CTDMA may require medium or relatively low complexity due to the CSI and time/frequency resources to be shared between APs. CSR may require low complexity as the amount of information related to spatial reuse and traffic that needs to be exchanged between APs may be low.

A multi-AP group may adopt a static multi-AP operation including a static multi-AP transmission scheme. A multi-AP network may also be dynamic due to various reasons. For example, a STA may join or leave the multi-AP network, a STA may switch to a power save mode, or an AP or a STA may change its location. Such changes may lead to changes in the conditions underlying the selection of the multi-AP transmission scheme and may cause certain requirements (e.g., synchronization, backhaul, coordination, etc.) for the multi-AP transmission scheme to be lost. This results in an inferior quality of transmissions in the multi-AP network.

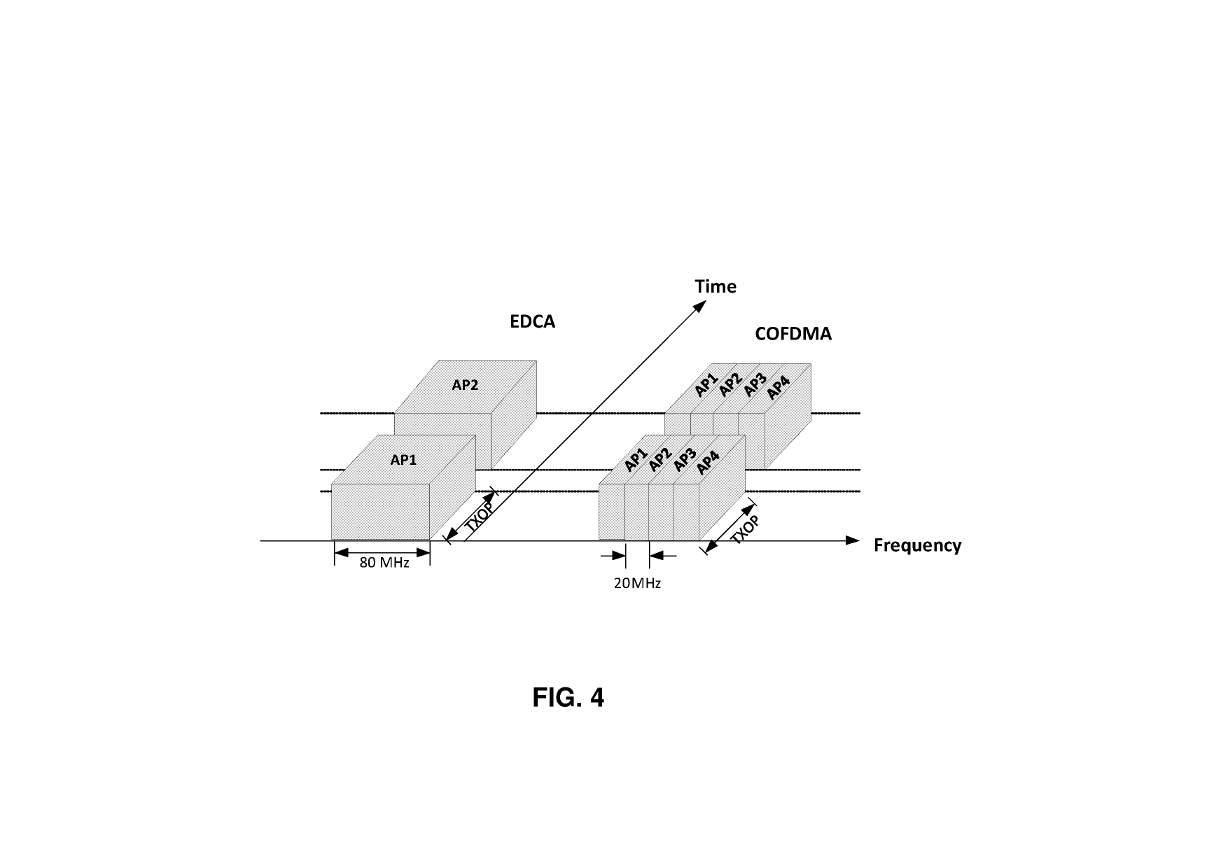

In COFDMA, the master AP may share a portion of its TXOP with multiple APs by assigning each of the multiple APs a respective frequency resource (e.g., channel/subchannel) of available frequency resources. COFDMA is illustrated in FIG. 4 as a multi-AP channel access, compared with Enhanced Distributed Channel Access (EDCA). As shown in FIG. 4, in EDCA, channel access by multiple APs (e.g., AP1, AP2) may occur in consecutive time periods (e.g., TXOPs). During a given channel access, the channel (e.g., 80 MHz) in its entirety may be used by a single AP. In contrast, in COFDMA, access by multiple APs (multi-AP channel access) may take place in a same time period (e.g., same TXOP or same portion of a TXOP) over orthogonal frequency resources. For example, as shown in FIG. 4, an 80 MHz channel may be divided into four non-overlapping 20 MHz channels, each assigned to a respective AP of the multiple APs. The multiple APs may transmit in a coordinated manner, simultaneously in the same time period, to achieve a multi-AP transmission. In the multi-AP transmission, each of the multiple APs may transmit a PPDU to one or more STAs.

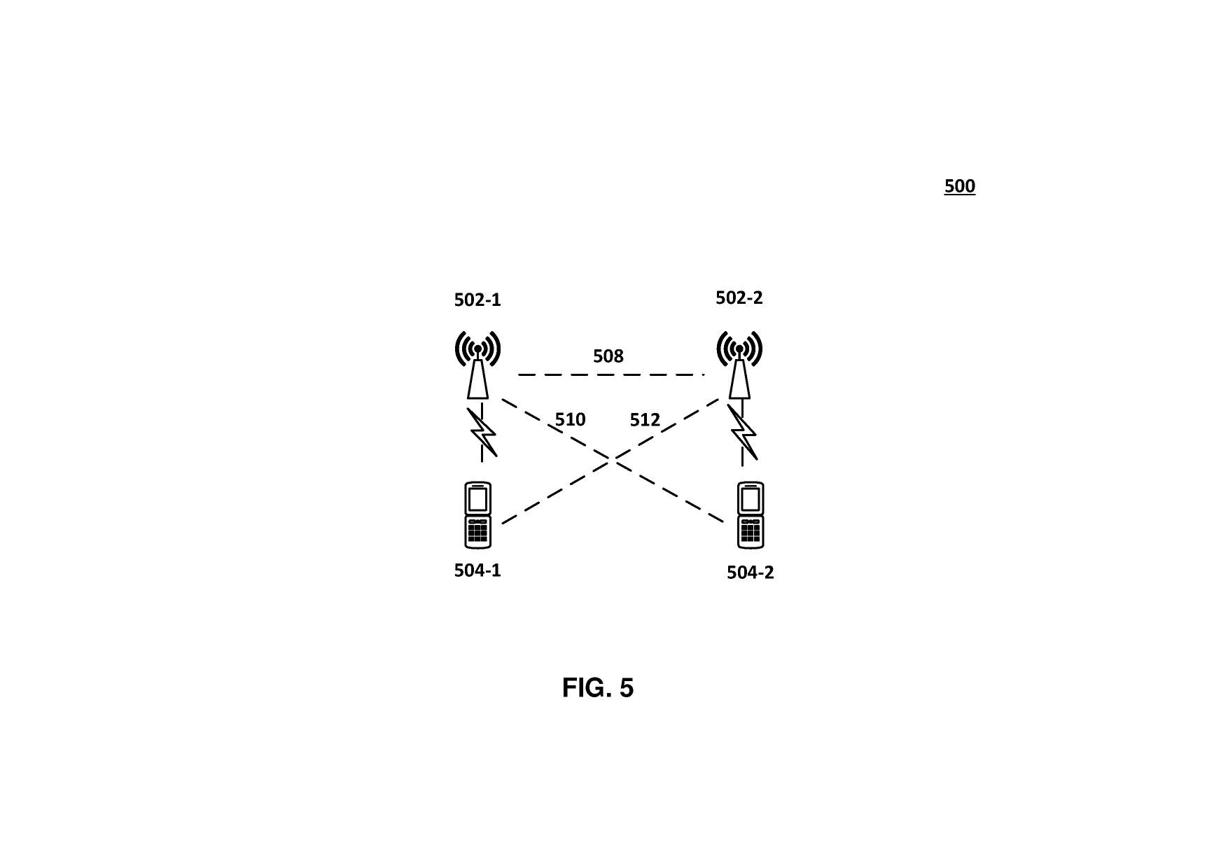

FIG. 5 illustrates an example network 500 that includes a coordinated AP set. As shown in FIG. 5, the coordinated AP set may include two APs – AP 502-1 and AP 502-2. The coordinated AP set may be a subset of an established multi-AP group. At least one STA may be associated with each of APs 502-1 and 502-2. For example, a STA 504-1 may be associated with AP 502-1, and a STA 504-2 may be associated with AP 502-2.

APs 502-1 and 502-2 may belong to the same ESS as described above in FIG. 1. In such a case, APs 502-1 and 502-2 may be connected by a DS to support ESS features. In addition, as part of a coordinated AP set, APs 502-1 and 502-2 may be connected by a backhaul. The backhaul is used to share information quickly between APs to support coordinated transmissions. The shared information may be channel state information or data to be sent to associated STAs. The backhaul may be a wired backhaul or a wireless backhaul. A wired backhaul is preferred for high-capacity information transfer without burdening the main radios of the APs. However, a wired backhaul may require a higher deployment cost and may place greater constraints on AP placement. A wireless backhaul is preferred for its lower deployment cost and flexibility regarding AP placement. However, because a wireless backhaul relies on the main radios of the APs to transfer information, the APs cannot transmit or receive any data while the wireless backhaul is being used.

Typically, one of APs 502-1 and 502-2 may act as a Master AP and the other as a Slave AP. The Master AP is the AP that is the owner of the TXOP. The Master AP shares frequency resources during the TXOP with the Slave AP. When there are more than two APs in the coordinated set, a Master AP may share its TXOP with only a subset of the coordinated AP set. The role of the Master AP may change over time. For example, the Master AP role may be assigned to a specific AP for a duration of time. Similarly, the Slave AP role may be chosen by the Master AP dynamically or can be pre-assigned for a duration of time.

Depending on the capability of APs in a coordinated AP set, the APs may only do certain type of coordinated transmissions. For example, in FIG. 5, if AP 502-1 supports JT and CSR while AP 502-2 supports CSR and CBF, both APs may only perform CSR as a coordinated transmission scheme. An AP may also prefer to perform single AP transmissions for a duration of time if the benefit of coordinated transmission does not outweigh some disadvantages with coordinated transmission such as reduced flexibility and increased computational power required.

CSR is one type of multi-AP coordination that may be supported by AP 501-1 and AP 502-2 as shown in FIG. 5. Spatial reuse using CSR can be more stable than non-AP coordinated spatial reuse schemes such as OBSS PD-based SR and PSR-based SR. For example, in example network 500, APs 502-1 and 502-2 may perform a joint sounding operation in order to measure path loss (PL) on paths of network 500. For example, the joint sounding operation may result in the measurement of PL 508 for the path between APs 502-1 and 502-2, path loss 510 for the path between AP 502-1 and STA 504-2, and path loss 512 for the path between AP 502-2 and STA 504-1. The measured path loss information may then be shared between APs 502-1 and 502-2 (e.g., using the backhaul) to allow for simultaneous transmissions by APs 502-1 and 502-2 to their associated STAs 504-1 and 504-2 respectively. Specifically, one of APs 502-1 and 502-2 obtains a TXOP to become the Master AP. The Master AP may then send a CSR announcement frame to the other AP(s). In an embodiment, the Master AP may perform a polling operation, before sending the CSR announcement frame, to poll Slave APs regarding packet availability for transmission. If at least one Slave AP responds indicating packet availability, the Master AP may proceed with sending the CSR announcement frame. In the CSR announcement, the Master AP may limit the transmit power of a Slave AP in order to protect its own transmission to its target STA. The Slave AP may similarly protect its own transmission to its target STA by choosing a modulation scheme that enables a high enough Signal to Interference Ratio (SIR) margin to support the interference due to the transmission of the Master AP to its target STA.

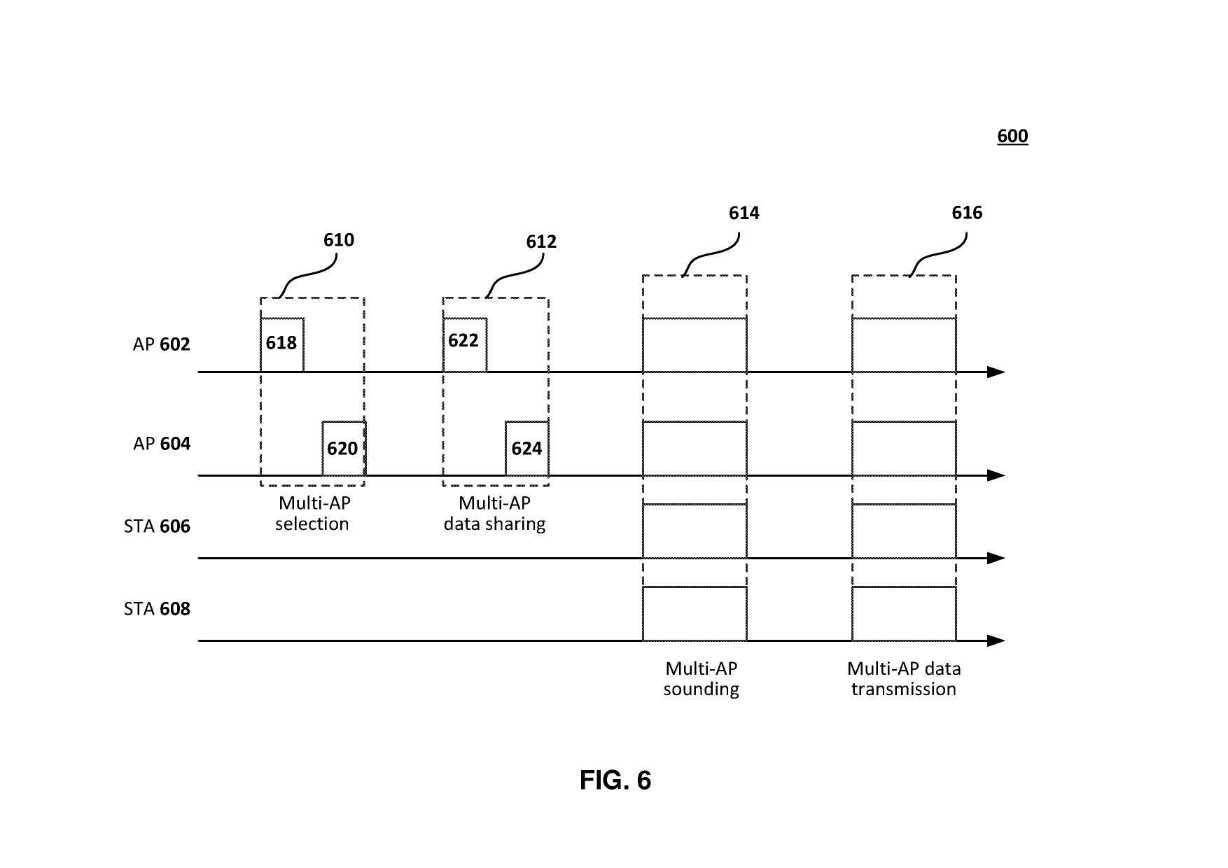

FIG. 6 illustrates an example 600 of a multi-AP operation procedure. In example 600, the multi-AP operation procedure is illustrated with respect to a multi-AP network that includes APs 602 and 604 and STAs 606 and 608. In an example, APs 602 and 604 may form a multi-AP group. AP 602 may be the master AP and AP 604 may be a slave AP of the multi-AP group. For example, AP 602 may obtain a TXOP making it the master AP of the multi-AP group. Alternatively, AP 602 may be designated as the master AP by a multi-AP controller.

As shown in FIG. 6, the multi-AP operation procedure may include a series of phases in time, each of which may contain a plurality of frame exchanges within the multi-AP network. Specifically, the multi-AP operation procedure may include a multi-AP selection phase 610, a multi-AP data sharing phase 612, a multi-AP sounding phase 614, and a multi-AP data transmission phase 616.

A multi-AP network may carry out a multi-AP operation based on a specific multi-AP transmission scheme. The multi-AP transmission scheme may be chosen by the master AP based on the capabilities of the slave APs in a multi-AP group. Prior to a multi-AP operation, a slave AP may inform the master AP of capability information related to the slave AP, including the capabilities of supporting one or more multi-AP transmission schemes. The slave AP may also inform the master AP of BSS information of the BSS of the slave AP and of link quality information for STAs associated with the slave AP. The master AP may receive information related to all available slave APs. The information related to slave APs may include capability information, BSS information, and link quality information. Based on the information provided by available slave APs, the master AP may determine during a multi-AP selection phase the slave APs to be designated for a multi-AP transmission and a specific multi-AP transmission scheme to be used during the multi-AP transmission.

Multi-AP selection phase 610 may include procedures for soliciting, selecting, or designating slave AP(s) for a multi-AP group by a master AP. As seen in FIG. 6, the multi-AP selection phase may include transmissions of frame 618 from AP 602 and frame 620 from AP 604. AP 602 may transmit frame 618 to solicit information regarding the buffer status of AP 604. In response, AP 604 may transmit frame 620 to inform AP 602 of its and its associated STAs buffer status and/or whether it intends to join multi-AP operation. Multi-AP selection phase 610 may also be used to exchange information related to multi-AP operation, including BSS information of APs and link quality information between each AP and its associated STAs, for example. The BSS information of an AP may include a BSS ID of the BSS of the AP, identifiers and/or capabilities of STAs belonging to the BSS, information regarding sounding capabilities of the STAs, information regarding MIMO capabilities of the AP, etc. Link quality information may include received signal strength indicator (RSSI), signal-to-noise ratio (SNR), signal-to-interference-plus-noise-ratio (SINR), channel state information (CSI), channel quality indicator (CQI).

Multi-AP data sharing phase 612 may include procedures for sharing data frames to be transmitted by APs to associated STAs among the master AP and selected slave AP(s) via direct connections between APs. Phase 612 may be optional for some multi-AP data transmission schemes. For example, phase 612 may be required for JT/JR as data frames may be exchanged between APs before or after multi-AP data transmission phase 616.

Multi-AP data sharing phase 612 may be performed using a wired backhaul, an in-channel wireless backhaul, or an off-channel wireless backhaul. In some cases, multi-AP data sharing phase 612 may be performed over an in-channel backhaul, e.g., using the same wireless channel used to transmit/receive data to/from STAs. For example, as shown in FIG. 6, in phase 612, AP 602 may transmit a frame 622, which may be received by AP 604. Frame 622 may include MPDUs that AP 602 wishes to transmit to associated STAs using a multi-AP operation. Similarly, AP 604 may transmit a frame 624, which may be received by AP 602. Frame 624 may include MPDUs that AP 604 wishes to transmit to associated STAs using a multi-AP operation.

Multi-AP sounding phase 614 may include procedures for multi-AP channel sounding, including channel estimation and feedback of channel estimates among the master AP, candidate slave AP(s), and associated STAs. Phase 614 may be optional for some multi-AP transmission schemes, such as COFDMA, CDTMA, and CSR. For example, phase 614 may be performed by the master AP to aid in resource unit allocation when orchestrating a COFDMA transmission.

Multi-AP data transmission phase 616 may include exchange of data frames between the master AP, slave AP(s), and their associated STAs based on multi-AP transmission scheme(s) determined by the master AP. Depending on the multi-AP transmission scheme(s) to be used, phase 616 may include optional synchronization between APs of the multi-AP group, before exchange of data frames between APs and STAs within the multi-AP group.

The order of phases 610, 612, 614 and 616 may be different than shown in FIG. 6. For example, in COFDMA, phase 616 may occur immediately after phase 610, whereas, in JT/JR, phase 612 may occur after phase 610. Further, as mentioned above, some phases may be optional and may or may not be present. For example, phase 614 may not be required for COFDMA but may be required for JT/JR.

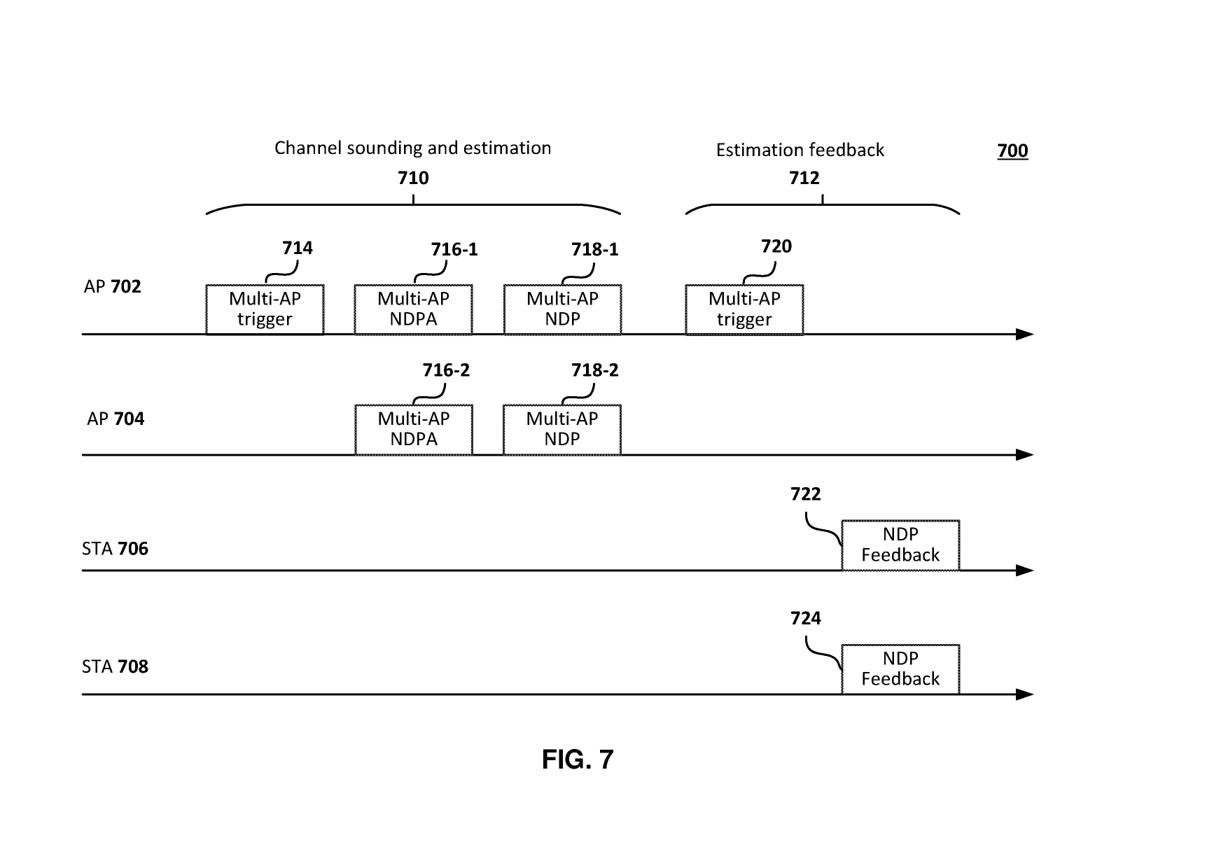

FIG. 7 illustrates an example 700 of a multi-AP sounding phase. Multi-AP sounding phase 700 may be an example of multi-AP sounding phase 614. As shown in FIG. 7, example 700 may include a master AP 702 and a slave AP 704 of a multi-AP group. Example 700 may further include a STA 706 associated with AP 702 and a STA 708 associated with AP 704.

As shown in FIG. 7, multi-AP sounding phase 700 may include frame exchanges to allow AP 702 (the master AP) to acquire channel state information (CSI) of channels in the multi-AP group. In an implementation, phase 700 may include a first subphase 710 and a second subphase 712.

During the first subphase 710, APs may initiate channel sounding and STAs may estimate channel state information (CSI). For example, AP 702 may transmit a frame 714 to AP 704 (the slave AP) to trigger multi-AP sounding. Frame 714 may comprise a multi-AP trigger frame. Subsequently, APs 702 and 704 may transmit respectively announcement frames 716-1 and 716-2 to their respective associated STAs 706 and 708 to announce the transmission of sounding frames. Frames 716-1 and 716-2 may comprise multi-AP null data packet announcement (NDPA) frames. Frames 716-1 and 716-2 may be transmitted simultaneously. Next, APs 702 and 704 may transmit respectively frames 718-1 and 718-2 to STAs 706 and 708 respectively. Frames 718-1 and 718-2 may comprise multi-AP null data packet (NDP) frames. STAs 706 and 708 receive frames 718-1 and 718-2 respectively and perform channel estimation of the channels from AP 702 to STA 706 and from AP 704 to STA 708, respectively.

During the second subphase 712, APs may initiate a procedure for STAs to feed back channel estimates to the APs. For example, AP 702 may transmit a frame 720 to trigger STAs 706 and 708 to transmit their channel estimates to APs 702 and 704 respectively. Frame 720 may comprise a multi-AP trigger frame. In response, STAs 706 and 708 may transmit respectively frames 722 and 724 including feedback of channel estimates to APs 702 and 704 respectively. Frames 722 and 724 may comprise NDP feedback frames. The feedback of channel estimates may include NDP feedback, CSI-related information, a beamforming report (BFR), or a channel quality indication (CQI) report.

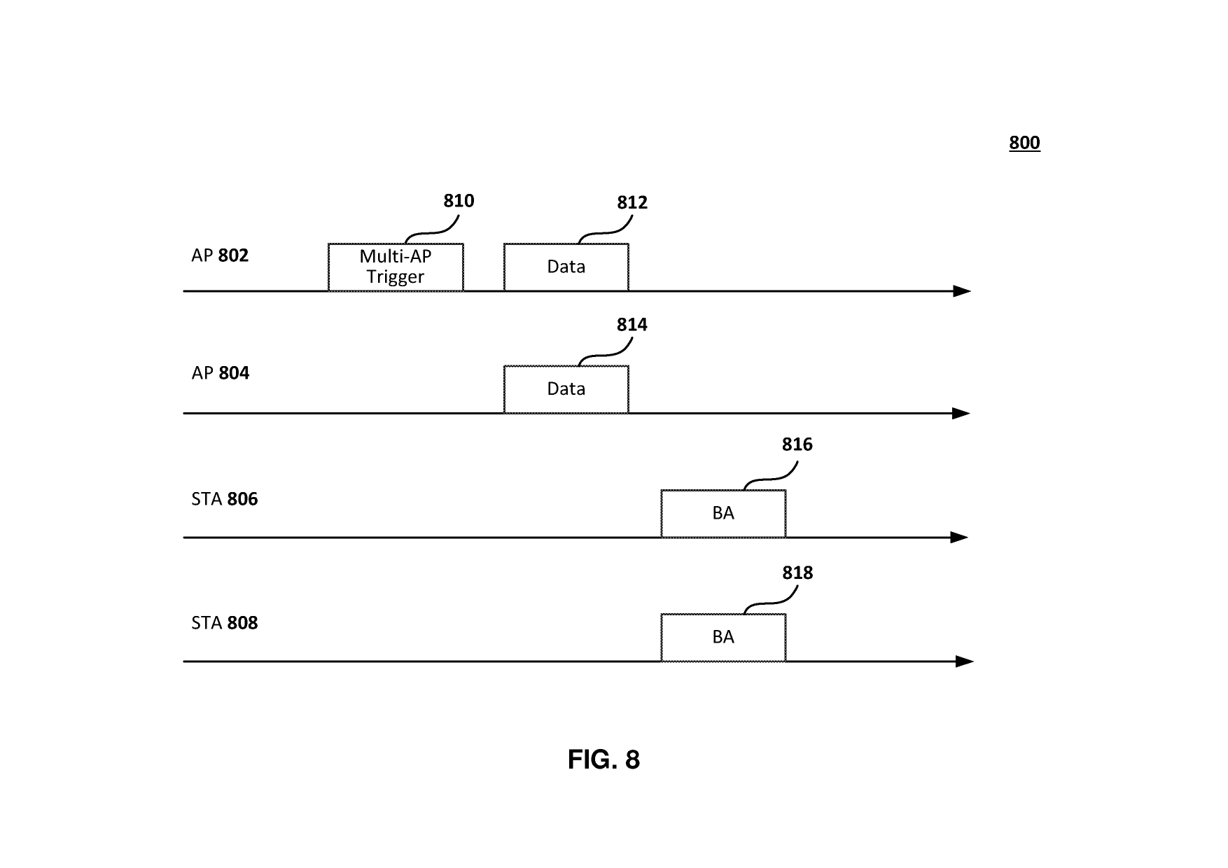

FIG. 8 illustrates an example 800 of a multi-AP downlink data transmission phase. Multi-AP downlink data transmission phase 800 may be an example of multi-AP data transmission phase 616. As shown in FIG. 8, example 800 may include a master AP 802 and a slave AP 804 of a multi-AP group. Example 800 may further include a STA 806 associated with AP 802, and a STA 808 associated with AP 804.

As shown in FIG. 8, multi-AP downlink data transmission phase 800 may include frame exchanges to enable master AP 802 to coordinate with slave AP 804 to perform specific multi-AP transmission schemes with their associated STAs 806 and 808 respectively. The multi-AP transmission schemes may include COFDMA, CTDMA, CSR, CBF, JT/JR, or a combination of two or more of the aforementioned schemes.

As shown in FIG. 8, master AP 802 may begin phase 800 by transmitting a frame 810 to AP 804. Frame 810 may include information related to AP 804 (e.g., an identifier of AP 804), synchronization information, information related to a specific multi-AP transmission scheme to be used, and/or information related to a resource unit (RU) for use by AP 804 to acknowledge frame 810. Frame 810 may comprise a control frame. For example, frame 810 may comprise a multi-AP trigger frame.

Slave AP 804 may receive frame 810 and may use the synchronization information to synchronize with master AP 802. Subsequently, APs 802 and 804 may perform data transmission to their associated STAs 806 and 808 respectively. Specifically, AP 802 may transmit a data frame 812 to its associated STA 806, and AP 804 may transmit a data frame 814 to its associated STA 808. Depending on the multi-AP transmission scheme being used, APs 802 and 804 may transmit frames 812 and 814 respectively to STAs in different BSSs. For example, when the multi-AP transmission scheme is JT/JR, AP 802 may also transmit frame 812 to STA 808 associated with slave AP 804, and AP 804 may also transmit frame 814 to STA 808 associated with AP 804. The resources for transmitting and receiving frames 812 and 814 may depend on the specific multi-AP transmission scheme adopted.

STAs 806 and 808 may acknowledge frames 812 and 814 respectively. For example, STA 806 may transmit a frame 816 to AP 802, and STA 808 may transmit a frame 818 to AP 804. Frames 816 and 818 may comprise block ack (BA) frames. STAs 804 and 814 may also transmit frames 816 and 818 to APs in different BSSs, when required by the used multi-AP transmission scheme. For example, when the multi-AP transmission scheme is JT/JR, STA 806 may also transmit frame 816 to AP 804, and STA 808 may also transmit frame 818 to AP 802. The resources for transmitting and receiving frames 816 and 818 may depend on the specific multi-AP transmission scheme adopted.

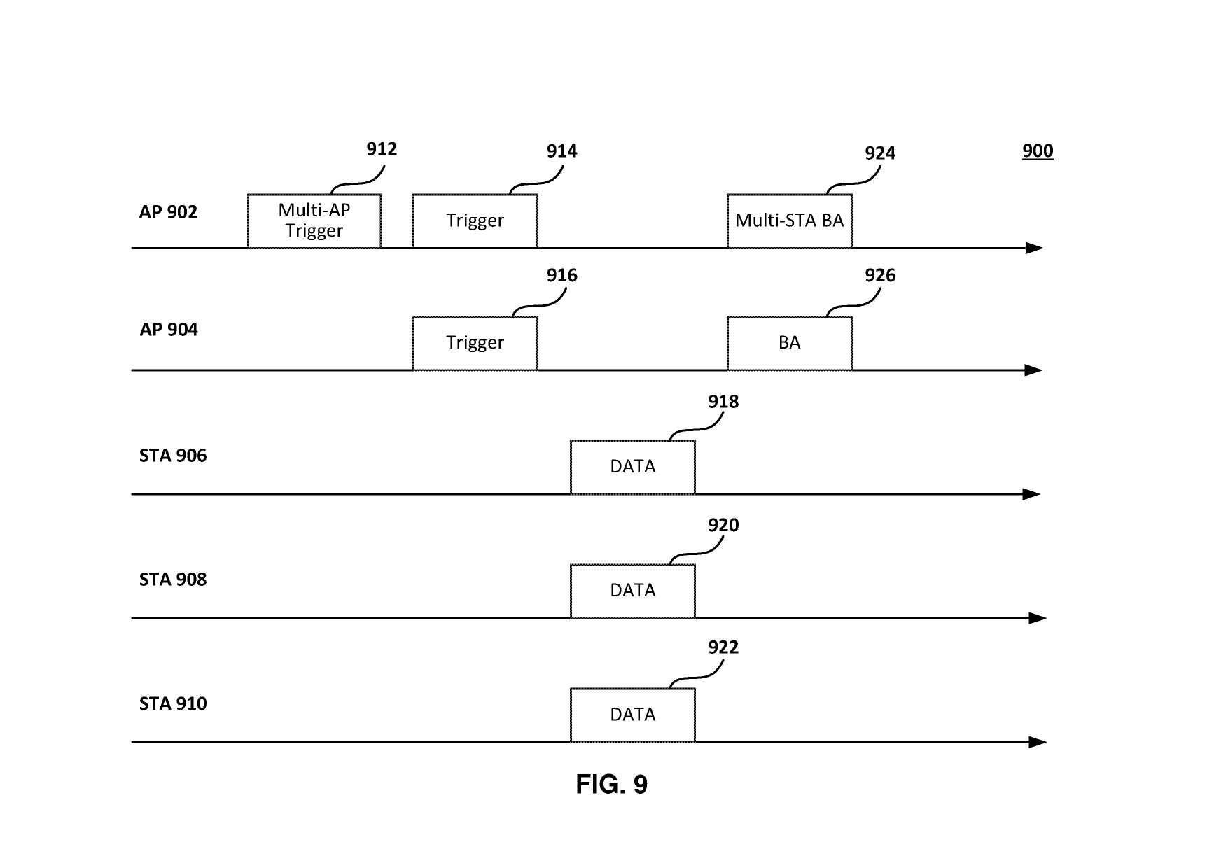

FIG. 9 illustrates an example 900 of a multi-AP uplink data transmission phase. Multi-AP uplink data transmission phase 900 may be an example of multi-AP data transmission phase 616. As shown in FIG. 9, example 900 may include a master AP 902 and a slave AP 904 of a multi-AP group. Example 900 may further include STAs 906 and 908 associated with AP 902, and a STA 910 associated with AP 904.

As shown in FIG. 9, multi-AP uplink data transmission phase 900 may include frame exchanges to enable master AP 902 to coordinate with slave AP 904 to perform specific multi-AP transmission schemes with STAs 906, 908, and 910910. The multi-AP transmission schemes may include COFDMA, CTDMA, CSR, CBF, JT/JR, or a combination of two or more of the aforementioned schemes.

As shown in FIG. 9, master AP 902 may begin phase 900 by transmitting a frame 912 to AP 904. Frame 912 may include information related to AP 904 (e.g., an identifier of AP 904), synchronization information, information related to a specific multi-AP transmission scheme to be used, and/or information related to an RU for use by AP 904 to acknowledge frame 912. Frame 912 may comprise a control frame. For example, frame 912 may comprise a multi-AP trigger frame.

Slave AP 904 may receive frame 912 and may use the synchronization information to synchronize with master AP 902. Subsequently, APs 902 and 904 may solicit uplink data transmissions from their associated STAs 906, 908 and 910 using trigger frames. Specifically, AP 902 may transmit a trigger frame 914 to its associated STAs 906 and 908, and AP 904 may transmit a trigger frame 916 to its associated STA 910. Depending on the multi-AP transmission scheme being used, APs 902 and 904 may also transmit frames 914 and 916 respectively to STAs in different BSSs. For example, when the multi-AP transmission scheme is JT/JR, AP 902 may also transmit frame 914 to STA 910 associated with slave AP 904, and AP 904 may also transmit frame 916 to STAs 906 and 908 associated with AP 902. The resources for transmitting and receiving frames 914 and 916 may depend on the specific multi-AP transmission scheme adopted.

STAs 906 and 908 may respond to frame 914, STA 910 may respond to frame 916. For example, STAs 906 and 908 may transmit frames 918 and 920 respectively to AP 902, while STA 910 may transmit a frame 922 to AP 904. Frames 918, 920, and/or 922 may be transmitted simultaneously. Frames 918, 920, and 922 may comprise data frames or null data frames. STAs 906, 908, and 910 may also transmit frames 918, 920, and 922 respectively to APs in different BSSs, when required by the used multi-AP transmission scheme. For example, when the multi-AP transmission scheme is JT/JR, STAs 906 and 908 may also transmit respective frames 918 and 920 to AP 904, and STA 910 may also transmit frame 922 to AP 902. The resources for transmitting and receiving frames 918, 920, and 922 may depend on the specific multi-AP transmission scheme adopted.

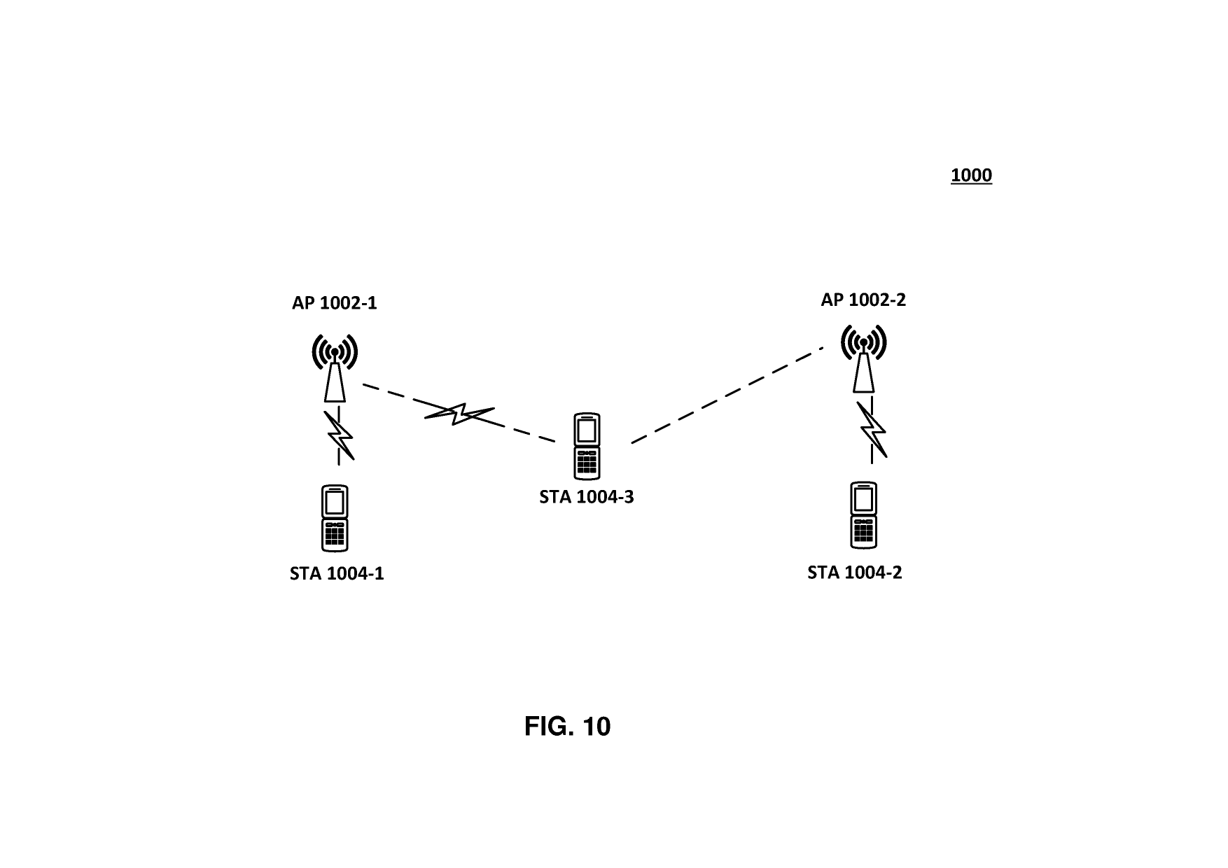

FIG. 10 is an example 1000 that illustrates interference that may be incurred by a STA operating in proximity to multiple APs. As shown in FIG. 10, example 1000 includes APs 1002-1 and 1002-2 and STAs 1004-1, 1004-2, and 1004-3. In an example, STAs 1004-1 and 1004-3 may be associated with AP 1002-1, and STA 1004-2 may be associated with AP 1002-2.

In an example, STA 1004-3 and AP 1002-2 may be within each other’s communication range. As such, AP 1002-2 may interfere with communications received by STA 1004-3 from AP 1002-1. Similarly, STA 1004-3 may interfere with communications received by AP 1002-2, for example from STA 1004-2.

In an example, APs 1002-1 and 1002-2 may not be within each other’s communication range. For example, AP 1002-1 may not hear transmissions from AP 1002-2 and/or AP 1002-2 may not hear transmissions from AP 1002-1. As such, APs 1002-1 and 1002-2 may not create a multi-AP group that may allow them to coordinate transmissions to reduce interference as described above.

Embodiments of the present disclosure, as further described below, address this problem that may arise in existing technologies by proposing station-assisted multi-AP coordination schemes. In one aspect, a STA associated with a first AP may receive from the first AP a first frame indicating a first period for communication by the first AP. The STA may transmit to a second AP a second frame indicating the first period for communication by the first AP. In an embodiment, the STA may further indicate in the second frame a received signal strength indicator of the first frame. The received signal strength indicator allows the second AP to ascertain the level of interference due to the first AP at or near the STA. The second AP may transmit a third frame indicating a second period for communication by the second AP, with the second period for communication based on the first period for communication by the first AP and the received signal strength indicator of the first frame. In another aspect, a STA may receive from a first AP a first frame indicating a first period for communication by the first AP. The STA may transmit to a second AP, with which the STA is associated, a second frame indicating the first period for communication by the first AP. In an embodiment, the STA may further indicate in the second frame a received signal strength indicator of the first frame. The received signal strength indicator allows the second AP to ascertain the level of interference due to the first AP at the STA. The second AP may transmit a third frame indicating a second period for communication by the second AP, with the second period for communication based on the first period for communication by the first AP and the received signal strength indicator of the second frame.

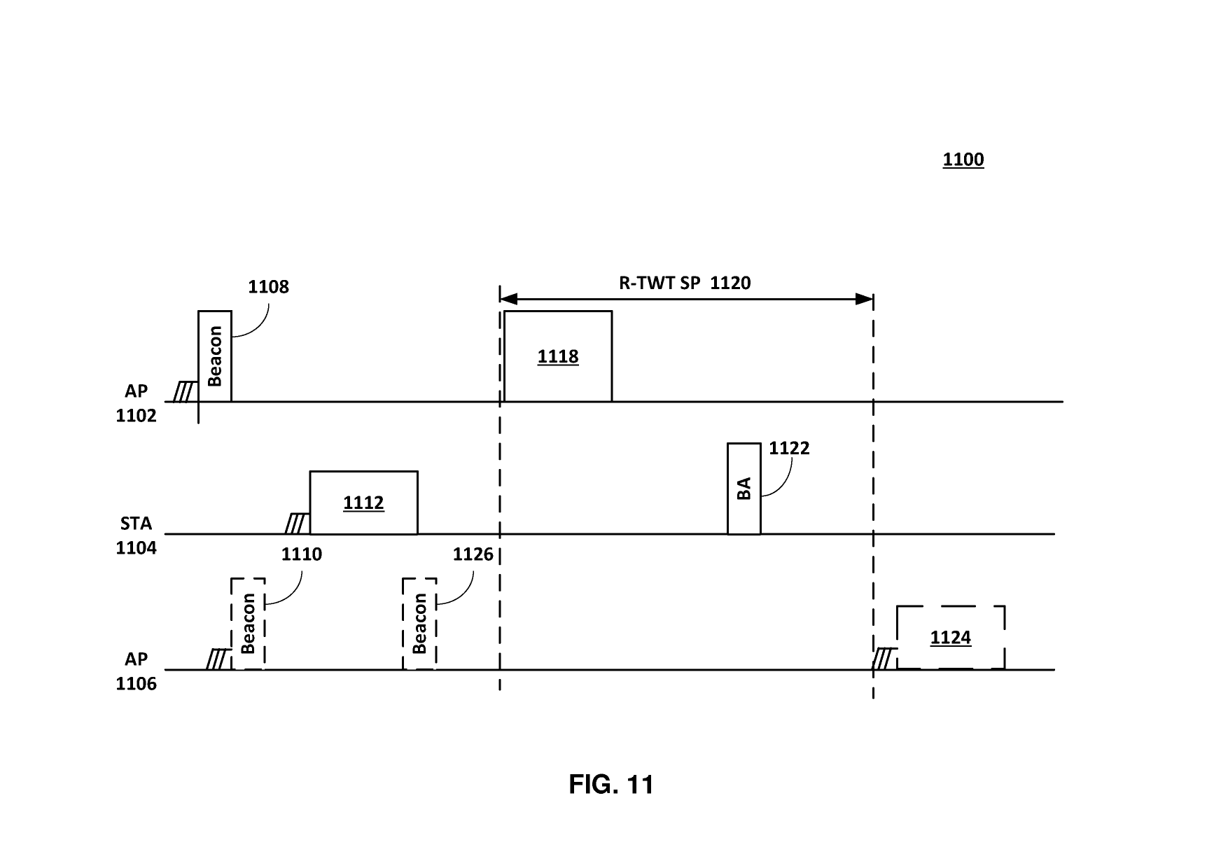

FIG. 11 is an example 1100 that illustrates station-assisted multi-AP coordination according to an embodiment. As shown in FIG. 11, example 1100 includes APs 1102 and 1106 and a STAs 1104. In an example, STA 1104 and AP 1102 may be within each other’s communication range. Similarly, STA 1104 and AP 1106 may be within each other’s communication range. However, APs 1102 and 1106 may not be within each other’s communication range. For example, AP 1102 may not hear transmissions from AP 1106 and/or AP 1106 may not hear transmissions from AP 1102. As such, APs 1102 and 1106 may not create a multi-AP group that may allow them to coordinate transmissions to reduce interference at or near STA 1104, for example.

In an example, STA 1104 may be associated with AP 1102. As shown in FIG. 11, example 1100 may begin with AP 1102 transmitting a beacon frame 1108. As STA 1104 is within the communication range of AP 1102 and is associated with AP 1102, STA 1104 may receive and decode beacon frame 1108. In an example, beacon frame 1108 may indicate a first period for communication by AP 1102. The first period for communication may include a restricted target wake time (r-TWT) service period (SP) 1120 scheduled by AP 1102. r-TWT SP 1120 may be scheduled for STA 1104 or for another STA associated with AP 1102 (not shown in FIG. 11). In an example, AP 1106 may be outside of the communication range of AP 1102 and thus may not receive beacon frame 1108.

In an embodiment, STA 1104 may determine a received signal strength indicator of beacon frame 1108. In an embodiment, the receive signal strength indicator may include a received channel power indicator (RCPI), a received signal strength indicator (RSSI), or a received signal-to-noise ratio indicator (RSNI) of beacon frame 1108.

In an embodiment, based on receiving beacon frame 1108, STA 1104 may transmit a frame 1112 to AP 1106. In an embodiment, frame 1112 may include the first period for communication by AP 1102 and the received signal strength indicator of beacon frame 1108.

In another embodiment, STA 1104 may transmit frame 1112 to AP 1106 on condition that the received signal strength indicator of beacon frame 1108 is above a threshold. That is, if the received signal strength indicator of beacon frame 1108 is below or equal to the threshold, STA 1104 may not transmit frame 1112 to AP 1106.

In another embodiment, STA 1104 may receive a frame 1110 (e.g., beacon) from AP 1106.

In an embodiment, STA 1104 may determine a received signal strength indicator of frame 1110. In an embodiment, the receive signal strength indicator may include an RCPI, an RSSI, or an RSNI of frame 1110. In an embodiment, STA 1104 may compare a difference or a ratio of the received signal strength indicator of beacon frame 1108 and the received signal strength indicator of frame 1110 to a pre-defined value. In an embodiment, STA 1104 may transmit frame 1112 on condition that the difference or the ratio of the received signal strength indicator of beacon frame 1108 and the received signal strength indicator of frame 1112 is greater than the pre-defined value.

In another embodiment, STA 1104 may determine a received signal strength indicator of frame 1110 and may transmit the determined received signal strength indicator of frame 1110 to AP 1106. In an embodiment, the received signal strength indicator of frame 1110 may be transmitted in frame 1112.

In an embodiment, based on receiving frame 1112, AP 1106 may transmit a frame (e.g., beacon) 1126 indicating a second period for communication by AP 1106. The second period for communication may be a future scheduled period such as an R-TWT SP. In another embodiment, based on receiving frame 1112, AP 1106 may transmit a frame 1124 indicating a second period for communication by AP 1106, where the second period for communication corresponds to a duration of transmission of frame 1124 itself. For example, frame 1124 may be an RTS frame, a data frame, a control frame, or a management frame.

In an embodiment, the second period for communication may be based on the first period for communication by AP 1102 and the received signal strength indicator of beacon frame 1108. The second period for communication by AP 1106 may comprise an R-TWT SP scheduled by AP 1106, a TXOP initiated by the second AP.

In an embodiment, the second period for communication by AP 1106 avoids (does not overlap with) the first period for communication by AP 1102 when the first received signal strength indicator of frame 1108 is above a first threshold. For example, as shown in FIG. 11, the first period for communication by AP 1102 may be an r-TWT SP 1120. By AP 1106 avoiding the first period for communication by AP 1102, AP 1102 may use r-TWT SP 1120 to transmit a downlink frame 1118 to STA 1104 and to receive a BA frame 1122 from STA 1104, without suffering any interference due to AP 1106. In another embodiment, AP 1102 may use r-TWT SP 1120 to communicate with a STA other than STA 1104.

In another embodiment, the second period for communication by AP 1106 overlaps the first period for communication by AP 1102 when the first received signal strength indicator of frame 1108 is lower than or equal to the first threshold.

In another embodiment, where the first received signal strength indicator of frame 1108 is lower than or equal to the first threshold, AP 1106 may further transmit a fourth frame (not shown in FIG. 11) within the first period for communication by AP 1102. In an embodiment, AP 1106 may transmit the fourth frame using a first transmit power when the first received signal strength indicator of frame 1108 is above a second threshold and may transmit the fourth frame using a second transmit power when the first received signal strength indicator of frame 1108 is below or equal to the second threshold. In an embodiment, the first transmit power is greater than the second transmit power.

In an embodiment, AP 1106 may receive from STA 1104 a second received signal strength indicator of a fourth frame (e.g., frame 1110) transmitted by AP 1106. In an embodiment, the second received signal strength indicator of the fourth frame may be received in frame 1112. In an embodiment, the second period for communication by AP 1106 is further based on the second received signal strength indicator of the fourth frame. In an embodiment, AP 1106 may compare the first received signal strength indicator of frame 1108 and the second received signal strength indicator of the fourth frame. In an embodiment, AP 1106 may compare a difference or a ratio of the first received signal strength indicator of frame 1108 and the second received signal strength indicator of the fourth frame to a pre-defined value. In an embodiment, the second period for communication by AP 1106 avoids the first period for communication by AP 1102 when the difference or the ratio of the first received signal strength indicator of frame 1108 and the second received signal strength indicator of the fourth frame is greater than the pre-defined value. In another embodiment, the second period for communication by AP 1106 overlaps the first period for communication by AP 1102 when the difference or the ratio of the first received signal strength indicator of frame 1108 and the second received signal strength indicator of the fourth frame is lower or equal than the pre-defined value.

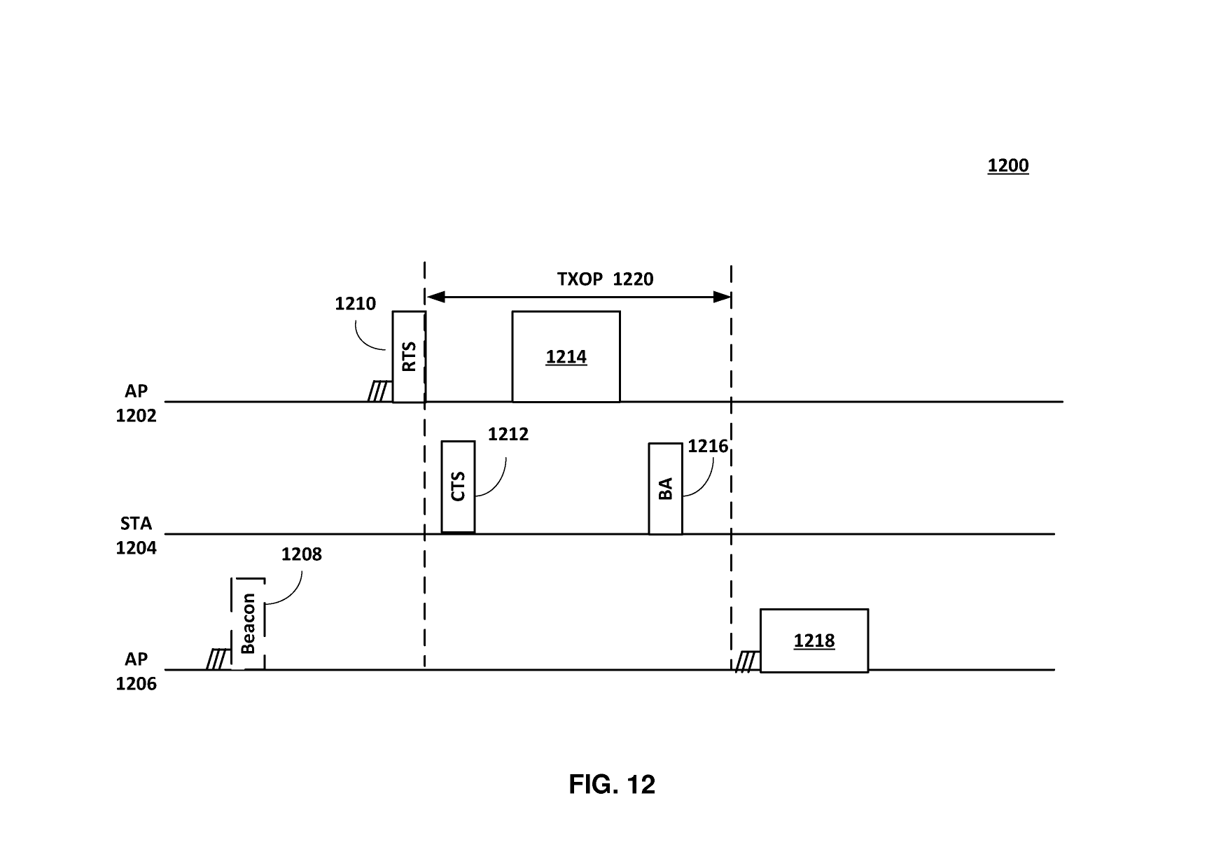

FIG. 12 is an example 1200 that illustrates station-assisted multi-AP coordination according to another embodiment. As shown in FIG. 12, example 1200 includes APs 1202 and 1206 and a STA 1204. In an example, STA 1204 and AP 1202 may be within each other’s communication range. Similarly, STA 1204 and AP 1206 may be within each other’s communication range. However, APs 1202 and 1206 may not be within each other’s communication range. For example, AP 1202 may not hear transmissions from AP 1206 and/or AP 1206 may not hear transmissions from AP 1202. As such, APs 1202 and 1206 may not create a multi-AP group that may allow them to coordinate transmissions to reduce interference at or near STA 1204, for example.

In an example, STA 1204 may be associated with AP 1202. As shown in FIG. 12, example 1200 may begin with AP 1206 transmitting a beacon frame 1208. As STA 1204 is within the communication range of AP 1206, STA 1204 may receive and decode beacon frame 1208. In an example, AP 1202 may be outside of the communication range of AP 1206 and thus may not receive beacon frame 1208.

In an embodiment, STA 1204 may determine a received signal strength indicator of beacon frame 1208. In an embodiment, the receive signal strength indicator may include a received channel power indicator (RCPI), a received signal strength indicator (RSSI), or a received signal-to-noise ratio indicator (RSNI) of beacon frame 1208.

In an example, before or after AP 1206 transmits beacon frame 1208, AP 1202 may transmit an RTS frame 1210 to STA 1204. RTS frame 1210 may indicate a first period for communication by AP 1202. The first period for communication by AP 1202 may include a TXOP 1220 initiated by RTS frame 1210. A duration of the first period for communication by AP 1202 may be indicated in a duration field of RTS frame 1210.

In an embodiment, based on receiving RTS frame 1210, STA 1204 may transmit a CTS frame 1212 to AP 1202. In an embodiment, CTS frame 1212 may indicate the first period for communication by AP 1202. In an example, the duration of the first period for communication by AP 1202 may be indicated in a duration field of CTS frame 1212.

In an embodiment, STA 1204 may determine a received signal strength indicator of RTS frame 1210. In an embodiment, the receive signal strength indicator may include an RCPI, an RSSI, or an RSNI of RTS frame 1210.

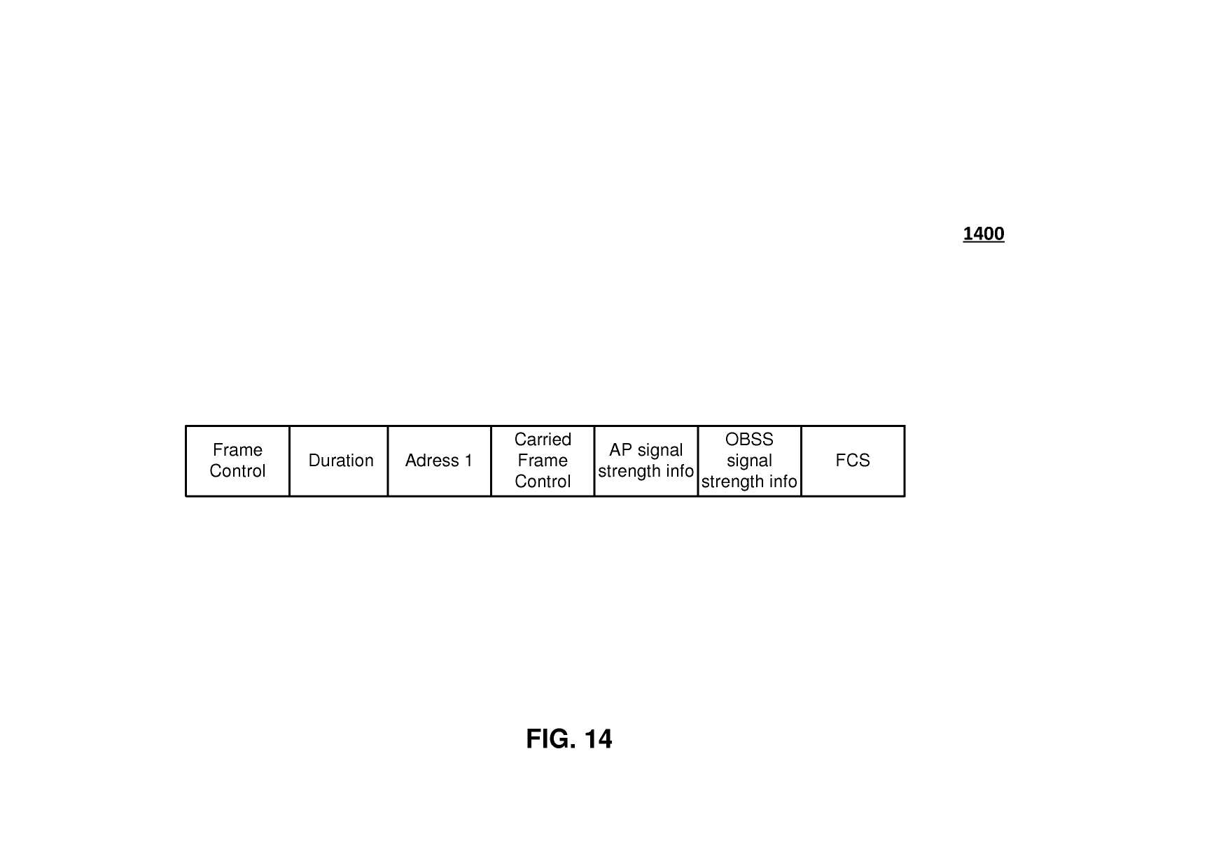

In an embodiment, CTS frame 1212 may further include the received signal strength indicator of RTS frame 1210, the received signal strength of beacon frame 1208, an identifier of AP 1202, and/or an identifier of AP 1206. In an embodiment, CTS frame 1212 may be carried in a control wrapper frame as described further below with respect to FIG. 14 or may be a standalone CTS frame.

In an embodiment, based on receiving CTS frame 1212, AP 1206 may defer from communicating during the first period for communication by AP 1202 indicated in CTS frame 1212. For example, as shown in FIG. 12, AP 1206 may wait until an end of TXOP 1220 before initiating transmission of a frame 1218 to an associated STA (not shown in FIG. 12.) In an embodiment, frame 1218 may indicate a second period for communication by AP 1206. The second period for communication may correspond to a duration of transmission of frame 1218 itself. For example, frame 1218 may be an RTS frame, a data frame, a control frame, or a management frame.

In another embodiment, based on receiving CTS frame 1212, AP 1206 may determine a second period for communication by AP 1206 based on the first period for communication by AP 1202, the received signal strength indicator of RTS frame 1210, and/or the received signal strength indicator of beacon frame 1208.

In an embodiment, AP 1206 may transmit during TXOP 1220 on the condition that a difference between the received signal strength indicator of RTS frame 1210 and the received signal strength indicator of beacon frame 1208 is above a threshold. The received signal strength indicator may include an RCPI, an RSSI, or an RSNI.

In another embodiment, AP 1206 may transmit during TXOP 1220 on the condition that a difference between the received signal strength indicator of RTS frame 1210 and a received signal strength indicator of CTS frame 1212 is above a threshold. This embodiment assumes reciprocity of the channel between AP 1206 and STA 1204 and that AP 1206 and STA 1204 use the same transmit powers to transmit beacon frame 1208 and CTS frame 1212 respectively. Under such assumptions, the received signal strength indicator of CTS frame 1212 may substitute the received signal strength indicator of beacon frame 1208. Accordingly, CTS frame 1212 may not include the received signal strength indicator of beacon frame 1208.

In example 1200, AP 1206 avoids the first period for communication by AP 1102, for example because the difference between the received signal strength indicator of RTS frame 1210 and the received signal strength indicator of beacon frame 1208 is below the threshold. For example, as shown in FIG. 12, the first period for communication by AP 1102 may be TXOP 1220. By AP 1206 avoiding the first period for communication by AP 1202, AP 1202 may use TXOP 1220 to transmit a downlink frame 1214 to STA 1204 and to receive a BA frame 1216 from STA 1204, without suffering any interference due to AP 1206.

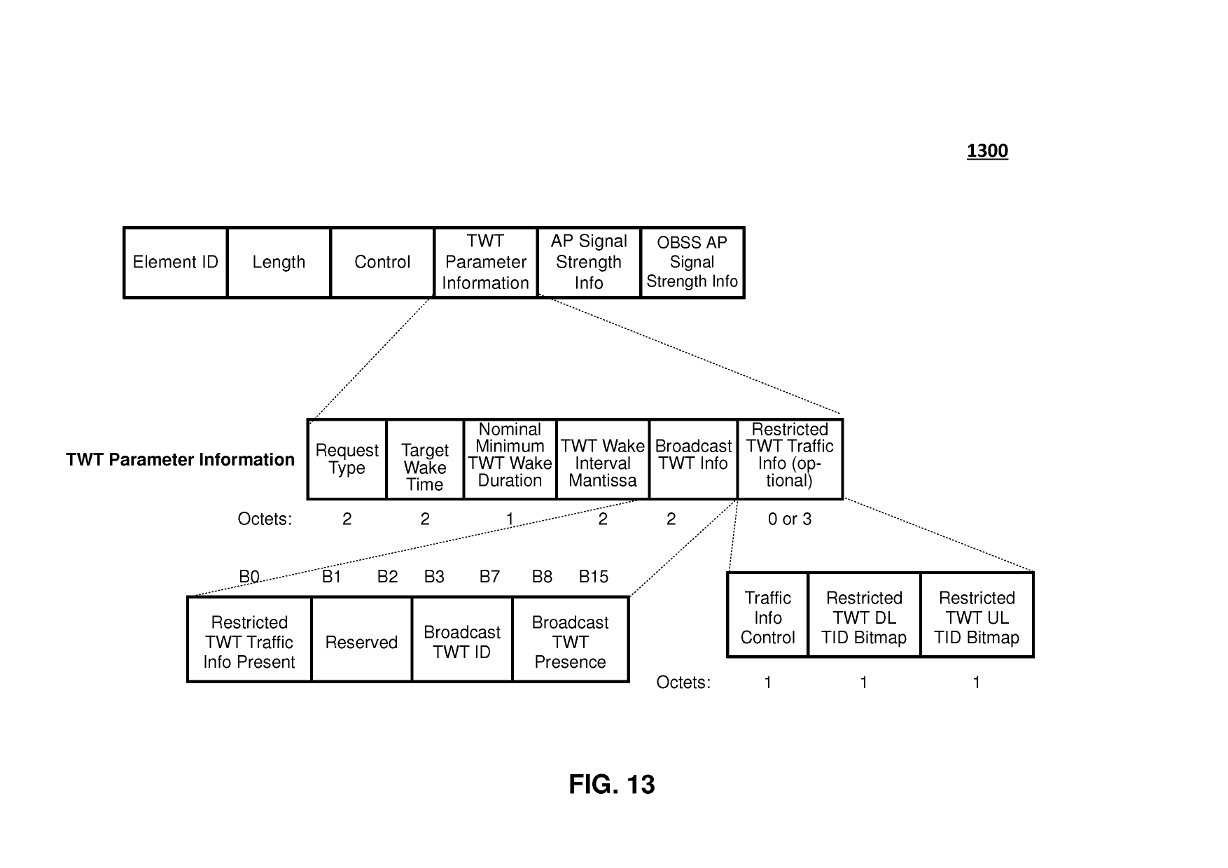

FIG. 13 illustrates a restricted target wake time (R-TWT) element 1300 which may be used in embodiments. In an embodiment, R-TWT element 1300 may be used by STA 1104 in frame 1112 to convey the first period for communication by AP 1102 to AP 1106 when the first period for communication includes an R-TWT SP, such as R-TWT SP 1120.

As shown in FIG. 13, element 1300 includes an element ID field, a length field, a control field, a TWT parameter information field, an AP signal strength info field, and an OBSS AP signal strength info field.

The element ID field (e.g., 1 octet in length) may indicate a type of R-TWT element 1300. The length field (e.g., 1 octet) may indicate the length of R-TWT element 1300 starting from the control field until an end of R-TWT element 1300.

The TWT parameter information may be used to carry information regarding the first period for communication by AP 1102 when the first period for communication by AP 1102 includes an R-TWT SP. STA 1104 may copy information regarding the R-TWT SP from an R-TWT element of beacon frame 1108 into corresponding fields on R-TWT element 1300.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional R-TWT traffic info field (e.g., 0 or 3 octets).

The request type field may include, among other fields, a TWT request field, a flow type field, and a TWT wake interval exponent field. The TWT request field indicates whether element 1300 is a request. If the TWT request field has a value of 0, then element 1300 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa) × 2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

The R-TWT traffic info field may include a traffic info control field, an R-TWT DL TID bitmap field, and an R-TWT UL TID bitmap field.

The traffic info control field may include a DL TID bitmap valid subfield and an UL TID bitmap valid subfield. The DL TID bitmap valid subfield indicates if the R-TWT DL TID bitmap field has valid information. When the value of the DL TID bitmap valid subfield is set to 0, it may indicate that DL traffic of TIDs is identified as latency sensitive traffic, and the R-TWT DL TID bitmap field is reserved. The UL TID bitmap valid subfield may indicate if the R-TWT UL TID bitmap field has valid information. When the value of the UL TID bitmap valid subfield is set to 0, it may indicate that UL traffic of TIDs is identified as latency sensitive traffic, and the R-TWT UL TID bitmap field is reserved.

The R-TWT DL TID bitmap subfield and the R-TWT UL TID bitmap subfield may specify which TID(s) are identified by the TWT scheduling AP or the TWT scheduled STA as latency sensitive traffic streams in a downlink and an uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

The AP signal strength info field includes a received signal strength indicator of a frame (e.g., beacon frame 1108) received from an AP (e.g., 1102) with which the STA (e.g., 1104) is associated. The AP signal strength info field may include a BSSID subfield indicating the BSS of the AP with which the STA is associated. As mentioned above, the received signal strength indicator may be an RCPI, an RSSI, or an RSNI.

The OBSS AP signal strength info field includes a received signal strength indicator of a frame (e.g., beacon frame 1110) received from an OBSS AP (e.g., 1106) relative to the STA (e.g., 1104) transmitting R-TWT element 1300. The OBSS AP signal strength info field may include a BSSID subfield indicating the BSS of the OBSS AP. As mentioned above, the received signal strength indicator may be an RCPI, an RSSI, or an RSNI.

FIG. 14 illustrates a control wrapper frame 1400 which may be used in embodiments. Control wrapper frame 1400 may be used to carry CTS frame 1212 described above in FIG. 12. Control wrapper frame 1400 may be a control wrapper frame as defined in the IEEE 802.11 standard.

As shown in FIG. 14, control wrapper frame 1400 may include a frame control field, a duration field, an address 1 field, a carried frame control field, an AP signal strength info field, an OBSS signal strength info field, and an FCS. In an embodiment, the AP signal strength info field and the OBSS signal strength info field replace an HT control field of the control wrapper frame as defined in the IEEE 802.11 standard.

The Frame control field indicates the type of control wrapper frame 1400.

The Duration field indicates a duration of control wrapper frame 1400 and is generated by following the rules for setting the Duration/ID field of the CTS frame being wrapped.

The Address 1 field indicates the receiver address of the CTS frame being wrapped.

The carried frame control field corresponds to the frame control field of the CTS frame being wrapped.

The AP signal strength info field includes a received signal strength indicator of a frame (e.g., beacon frame 1108) received from an AP (e.g., 1102) with which the STA (e.g., 1104) is associated. The AP signal strength info field may include a BSSID subfield indicating the BSS of the AP with which the STA is associated. As mentioned above, the received signal strength indicator may be an RCPI, an RSSI, or an RSNI.

The OBSS AP signal strength info field includes a received signal strength indicator of a frame (e.g., beacon frame 1110) received from an OBSS AP (e.g., 1106) relative to the STA (e.g., 1104) transmitting R-TWT element 1300. The OBSS AP signal strength info field may include a BSSID subfield indicating the BSS of the OBSS AP. As mentioned above, the received signal strength indicator may be an RCPI, an RSSI, or an RSNI.

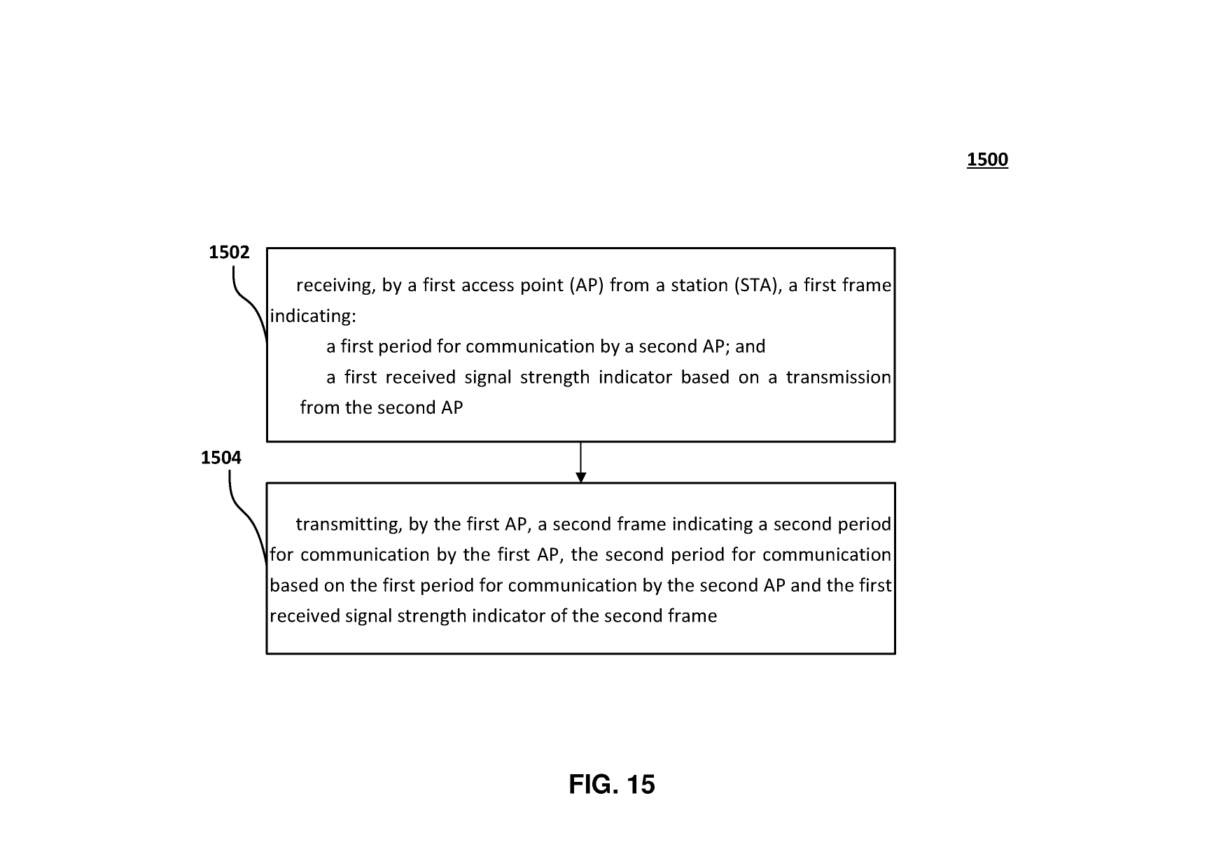

FIG. 15 illustrates an example process 1500 according to an embodiment. Example process 1500 is provided for the purpose of illustration only and is not limiting of embodiments. Process 1500 may be performed by a first AP, such as AP 1106 or 1206. As shown in FIG. 15, process 1500 includes steps 1502 and 1504.

Step 1502 includes receiving, by the first AP from a STA, a first frame indicating: a first period for communication by a second AP; and a first received signal strength indicator based on a transmission from the second AP. In an embodiment, the STA is associated with the second AP. In an embodiment, the second AP is an OBSS AP relative to the first AP. In an embodiment, the first AP is outside a communication range of the second AP.

In an embodiment, the first frame comprises a management frame or a CTS frame.

In an embodiment, the first period for communication by the second AP comprises an R-TWT SP scheduled by the second AP or a TXOP initiated by the second AP.

In an embodiment, the transmission comprises a third frame transmitted by the second AP and indicating the first period for communication by the second AP.

In an embodiment, the first received signal strength indicator comprises an RCPI, an RSSI, or an RNSI of the third frame.

In an embodiment, wherein the third frame comprises a beacon frame or an RTS frame.

Step 1504 includes transmitting, by the first AP, a second frame indicating a second period for communication by the first AP, the second period for communication based on the first period for communication by the second AP and the first received signal strength indicator of the second frame.

In an embodiment, the second period for communication by the first AP comprises an R-TWT SP scheduled by the second AP or a TXOP initiated by the second AP.

In an embodiment, the second period for communication by the first AP avoids the first period for communication by the second AP when the first received signal strength indicator of the third frame is above a first threshold.

In an embodiment, wherein the second period for communication by the first AP overlaps the first period for communication by the second AP when the first received signal strength indicator of the third frame is lower than or equal to the first threshold.

In an embodiment, where the first received signal strength indicator of the third frame is lower than or equal to the first threshold, process 1500 may further comprise transmitting, by the first AP, a fourth frame within the first period for communication by the second AP. In an embodiment, transmitting the fourth frame comprises transmitting the fourth frame using a first transmit power when the first received signal strength indicator of the third frame is above a second threshold; and transmitting the fourth frame using a second transmit power when the first received signal strength indicator of the third frame is below or equal to the second threshold. In an embodiment, the first transmit power is greater than the second transmit power.

In an embodiment, process 1500 may further comprise receiving, by the first AP from the STA, a second received signal strength indicator of a fifth frame transmitted by the first AP. In an embodiment, receiving the second received signal strength indicator comprises receiving the second received signal strength indicator in the first frame. In an embodiment, the second period for communication is further based on the second received signal strength indicator of the fifth frame.

In an embodiment, process 1500 may further comprise comparing the first received signal strength indicator and the second received signal strength indicator of the fifth frame. In an embodiment, process 1500 may further comprise comparing a difference or a ratio of the first received signal strength indicator and the second received signal strength indicator of the fifth frame to a pre-defined value. In an embodiment, the second period for communication by the first AP avoids the first period for communication by the second AP when the difference or the ratio of the first received signal strength indicator and the second received signal strength indicator of the fifth frame is greater than the pre-defined value. In an embodiment, the second period for communication by the first AP overlaps the first period for communication by the second AP when the difference or the ratio of the first received signal strength indicator and the second received signal strength indicator of the fifth frame is lower than or equal than the pre-defined value.

In an embodiment, the first frame comprises a CTS frame. In an embodiment, the transmission comprises an RTS frame from the second AP to the STA. In an embodiment, where the first frame comprises a CTS frame, the transmission comprises a RTS frame from the second AP to the STA.

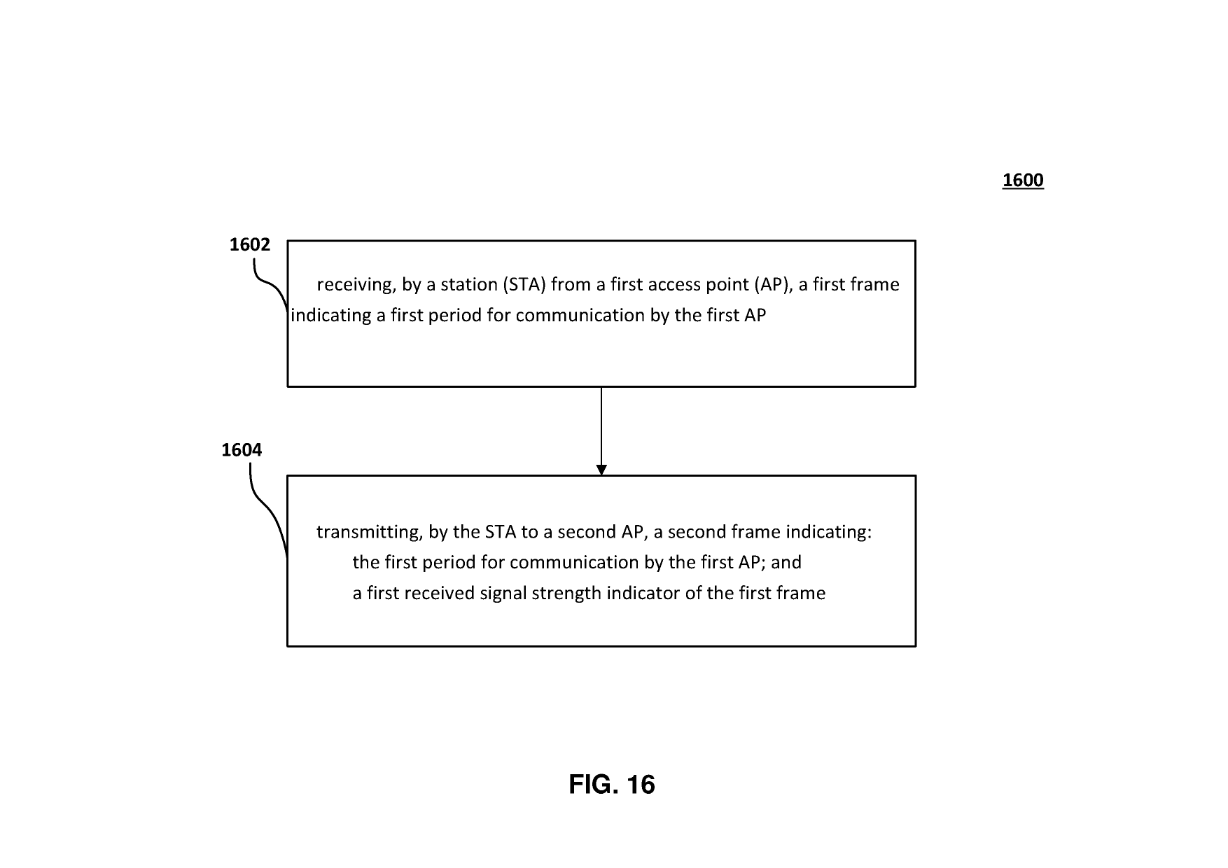

FIG. 16 illustrates an example process 1600 according to an embodiment. Example process 1600 is provided for the purpose of illustration only and is not limiting embodiments. Process 1600 may be performed by a STA, such as STA 1104 or 1204.

Step 1602 includes receiving, by the STA from a first access point AP, a first frame indicating a first period for communication by the first AP. In an embodiment, the STA is associated with the first AP. In an embodiment, the first frame comprises a comprises a beacon frame or an RTS frame.

In an embodiment, the first period for communication by the first AP comprises an R-TWT SP scheduled by the first AP or a TXOP initiated by the first AP.

Step 1604 includes transmitting, by the STA to a second AP, a second frame indicating: the first period for communication by the first AP; and a first received signal strength indicator of the first frame. In an embodiment, the second AP is an OBSS AP relative to the first AP. In an embodiment, the second AP is outside the communication range of the first AP. In an embodiment, the second frame comprises management frame.

In an embodiment, the first received signal strength indicator comprises an RCPI, a an RSSI, or an RSNI of the first frame.

In an embodiment, transmitting the second frame comprises transmitting the second frame on condition that the first received signal strength indicator of the first frame is above a threshold.

In an embodiment, process 1600 may further comprise receiving, by the STA from the second AP, a third frame. In an embodiment, process 1600 further comprises: comparing a difference or a ratio of the first received signal strength indicator of the first frame and a second received signal strength indicator of the third frame to a pre-defined value; and transmitting the second frame on condition that the difference or the ratio of the first received signal strength indicator of the first frame and the second received signal strength indicator of the third frame is greater than the pre-defined value

In an embodiment, process 1600 may further comprise transmitting, by the STA to the second AP, a second received signal strength indicator of a fourth frame transmitted by the second AP. In an embodiment, transmitting the second received signal strength indicator comprises transmitting the second received signal strength indicator in the second frame.

What Is Claim Is:

1. A station (STA) comprising:
one or more processors; and
memory storing instructions that, when executed by the one or more processors, cause the STA to:
receive, from a first access point (AP), a first frame indicating a first period for communication by the first AP; and
transmit, to a second AP, a second frame indicating:
the first period for communication by the first AP; and
a first received signal strength indicator of the first frame.

2. The STA of claim 1, wherein the first frame comprises a comprises a beacon frame or a request to send (RTS) frame and wherein the second frame comprises a management frame.

3. The STA of claim 1, wherein the first period for communication by the first AP comprises a restricted target wake time (R-TWT) service period (SP) scheduled by the first AP for a transmission opportunity (TXOP) initiated by the first AP.

4. The STA of claim 1, wherein the second AP is an overlapping basic service set (OBSS) AP.

5. The STA of claim 1,
wherein the second AP is outside a communication range of the first AP,
wherein the first received signal strength indicator comprises a received channel power indicator (RCPI), a received signal strength indicator (RSSI), or a received signal-to-noise ratio indicator (RSNI) of the first frame, and
wherein transmitting the second frame comprises transmitting the second frame on condition that the first received signal strength indicator of the first frame is above a threshold.

6. The STA of claim 1, wherein the instructions further cause the STA to:
receive, from the second AP, a third frame; and
compare a difference or a ratio of the first received signal strength indicator of the first frame and a second received signal strength indicator of the third frame to a pre-defined value.

7. The STA of claim 6, wherein the instructions further cause the STA to transmit the second frame on condition that the difference or the ratio of the first received signal strength indicator of the first frame and the second received signal strength indicator of the third frame is greater than the pre-defined value.

8. A first access point (AP) comprising:
one or more processors; and
memory storing instructions that, when executed by the one or more processors, cause the first AP to:
receive, from a station (STA), a first frame indicating:
a first period for communication by a second AP; and
a first received signal strength indicator based on a transmission from the second AP; and
transmit a second frame indicating a second period for communication by the first AP, the second period for communication based on the first period for communication by the second AP and the first received signal strength indicator.

9. The first AP of claim 8, wherein the STA is associated with the second AP and wherein the first frame comprises a management frame or a CTS frame.

10. The first AP of claim 8, wherein the first period for communication by the second AP comprises a restricted target wake time (R-TWT) service period (SP) scheduled by the second AP or a transmission opportunity (TXOP) initiated by the second AP.

11. The first AP of claim 8, wherein the second AP is an overlapping basic service set (OBSS) AP with the first AP and wherein the first AP is outside a communication range of the second AP.

12. The first AP of claim 8, wherein the transmission comprises a third frame transmitted by the second AP and indicating the first period for communication by the second AP, and wherein the third frame comprises a beacon frame or a request to send (RTS) frame.

13. The first AP of claim 12, wherein the second period for communication by the first AP comprises a restricted target wake time (R-TWT) service period (SP) scheduled by the second AP, for a transmission opportunity (TXOP) initiated by the second AP.

14. The first AP of claim 13, wherein the second period for communication by the first AP either:
avoids the first period for communication by the second AP when the first received signal strength indicator of the third frame is above a first threshold, or
overlaps the first period for communication by the second AP when the first received signal strength indicator of the third frame is lower than or equal to the first threshold.

15. A non-transitory computer-readable medium comprising instructions that, when executed by one or more processors of a station (STA), cause the STA to:
receive, from a first access point (AP), a first frame indicating a first period for communication by the first AP; and
transmit, to a second AP, a second frame indicating:
the first period for communication by the first AP; and
a first received signal strength indicator of the first frame.

16. The non-transitory computer-readable medium of claim 15, wherein the first frame comprises a comprises a beacon frame or a request to send (RTS) frame and wherein the second frame comprises a management frame.

17. The non-transitory computer-readable medium of claim 15, wherein the first period for communication by the first AP comprises a restricted target wake time (R-TWT) service period (SP) scheduled by the first AP for a transmission opportunity (TXOP) initiated by the first AP.

18. The non-transitory computer-readable medium of claim 15,
wherein the second AP is outside a communication range of the first AP,
wherein the first received signal strength indicator comprises a received channel power indicator (RCPI), a received signal strength indicator (RSSI), or a received signal-to-noise ratio indicator (RSNI) of the first frame, and
wherein transmitting the second frame comprises transmitting the second frame on condition that the first received signal strength indicator of the first frame is above a threshold.

19. The non-transitory computer-readable medium of claim 15, wherein the instructions further cause the STA to:
receive, from the second AP, a third frame; and
compare a difference or a ratio of the first received signal strength indicator of the first frame and a second received signal strength indicator of the third frame to a pre-defined value.

20. The non-transitory computer-readable medium of claim 19, wherein the instructions further cause the STA to transmit the second frame on condition that the difference or the ratio of the first received signal strength indicator of the first frame and the second received signal strength indicator of the third frame is greater than the pre-defined value.
